(19) United States
(12) Patent Application Publication
(10) Pub. No.: US 2026/0214033 A1
(43) Pub. Date: Jul. 23, 2026

(54) ENHANCED PRE-EMPTION FOR MULTI-CONSECUTIVE SLOT TRANSMISSION

(71) Applicant: QUALCOMM Incorporated, San Diego, CA (US)

(72) Inventors: Luanxia YANG, Beijing (CN); Jing SUN, San Diego, CA (US); Shaozhen GUO, Beijing (CN); Changlong XU, Beijing (CN); Chih-Hao LIU, San Diego, CA (US); Xiaoxia ZHANG, San Diego, CA (US); Siyi CHEN, Beijing (CN); Hao XU, Beijing (CN)

(21) Appl. No.: 19/139,820

(22) PCT Filed: Jan. 18, 2023
(86) PCT No.: PCT/CN2023/072835

§ 371 Date: Jun. 16, 2025

(51) Int. Cl. H04L 43/065; H04L 5/00

(52) U.S. Cl. CPC H04L 43/065; H04L 5/0005

(57) ABSTRACT

Methods, systems, and devices for wireless communications are described. For instance, a first UE may receive an indication of a set of resources available for preemption. The indication of the set of resources may include an indication of a group of consecutive resources. The first UE may select a first group of consecutive resources for transmitting a first message and may determine that second UE has reserved a first resource of the set of resources that overlaps with the first group of consecutive resources. The first UE may report an indication that the first resource is being preempted based on the overlap. The first UE may perform the reporting based on a first priority of a second message for the first resource relative to a second priority of the first message. The first UE may transmit the first message over a second group of consecutive resources based on the reporting.

### CROSS REFERENCE

The present Application is a 371 national phase filing of International PCT Application No. PCT/CN2023/072835 by YANG et al., entitled “ENHANCED PRE-EMPTION FOR MULTI-CONSECUTIVE SLOT TRANSMISSION,” filed Jan. 18, 2023, which is assigned to the assignee hereof, and which is expressly incorporated by reference in its entirety herein.

### FIELD OF TECHNOLOGY

The following relates to wireless communications, including enhanced pre-emption for multi-consecutive slot transmission.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Some communications systems may support sidelink communications where UEs may transmit directly to each other. In some cases, UEs may select resources of a resource pool to use for sidelink transmissions to other UEs. For example, a first user equipment (UE) and a second UE may perform communications using resources of a resource pool. In some aspects, the second UE may attempt to reserve a resource of the resource pool that has already been reserved by the first UE. If the first UE and the second UE each transmit over the reserved resource, their corresponding transmissions may interfere. This interference may reduce a likelihood that receiving devices receive the corresponding transmissions and may, accordingly, increase a likelihood that the first UE and the second UE retransmit their corresponding transmissions. Increasing likelihood of retransmissions may reduce an efficiency of wireless communications.

### SUMMARY

The present disclosure relates to methods, systems, devices, and apparatuses that support enhanced pre-emption for multi-consecutive slot transmission. For example, the described techniques provide for a user equipment (UE) to resolve preemption for resources reserved by a first UE for a multi-consecutive slot transmission (MCSt) that overlap with resources reserved by other UEs. For instance, a first UE may receive, at a first layer of the first UE and from a second layer of the first UE, an indication of a set of resources available for preemption. In some such examples, the indication of the set of resources may include an indication of one or more groups of consecutive resources. The first UE may select a first group of consecutive resources for transmitting a message and may determine that the second UE has reserved a first resource of the set of resources that overlaps at least partially with the first group of consecutive resources (e.g., in time and frequency). For instance, the first UE may receive sidelink control information (SCI) indicating that the first resource has been reserved by the second UE. The first UE may report, from the first layer to the second layer, an indication that the first resource is being preempted based on receiving the indication that the second UE has reserved the first resource of the set of resources. Additionally, the first UE may perform the reporting based on a first priority of a second message for which the first resource is reserved by the second UE relative to a second priority of the first message over the first group of consecutive resources. The first UE may transmit the first message over a second group of consecutive resources distinct from the first group of consecutive resources based on the reporting.

A method for wireless communication at a first user equipment (UE) is described. The method may include receiving, at a first layer of the first UE and from a second layer of the first UE, an indication of a set of resources available for preemption, where the indication of the set of resources includes an indication of one or more groups of consecutive resources, selecting a first group of consecutive resources for transmitting a message, where the first group of consecutive resources overlaps with a first resource of the set of resources available for preemption, determining that a second UE has reserved the first resource of the set of resources, reporting, from the first layer to the second layer, an indication that the first resource is being preempted based on determining that the second UE has reserved the first resource of the set of resources, and transmitting the message over a second group of consecutive resources distinct from the first group of consecutive resources based on the reporting.

An apparatus for wireless communication at a first UE is described. The apparatus may include a processor, memory coupled with the processor, and instructions stored in the memory. The instructions may be executable by the processor to cause the apparatus to receive, at a first layer of the first UE and from a second layer of the first UE, an indication of a set of resources available for preemption, where the indication of the set of resources includes an indication of one or more groups of consecutive resources, select a first group of consecutive resources for transmitting a message, where the first group of consecutive resources overlaps with a first resource of the set of resources available for preemption, determine that a second UE has reserved the first resource of the set of resources, reporting, from the first layer to the second layer, an indication that the first resource be being preempted based on determining that the second UE has reserved the first resource of the set of resources, and transmit the message over a second group of consecutive resources distinct from the first group of consecutive resources based on the reporting.

Another apparatus for wireless communication at a first UE is described. The apparatus may include means for receiving, at a first layer of the first UE and from a second layer of the first UE, an indication of a set of resources available for preemption, where the indication of the set of resources includes an indication of one or more groups of consecutive resources, means for selecting a first group of consecutive resources for transmitting a message, where the first group of consecutive resources overlaps with a first resource of the set of resources available for preemption, means for determining that a second UE has reserved the first resource of the set of resources, means for reporting, from the first layer to the second layer, an indication that the first resource is being preempted based on determining that the second UE has reserved the first resource of the set of resources, and means for transmitting the message over a second group of consecutive resources distinct from the first group of consecutive resources based on the reporting.

A non-transitory computer-readable medium storing code for wireless communication at a first UE is described. The code may include instructions executable by a processor to receive, at a first layer of the first UE and from a second layer of the first UE, an indication of a set of resources available for preemption, where the indication of the set of resources includes an indication of one or more groups of consecutive resources, select a first group of consecutive resources for transmitting a message, where the first group of consecutive resources overlaps with a first resource of the set of resources available for preemption, determine that a second UE has reserved the first resource of the set of resources, reporting, from the first layer to the second layer, an indication that the first resource be being preempted based on determining that the second UE has reserved the first resource of the set of resources, and transmit the message over a second group of consecutive resources distinct from the first group of consecutive resources based on the reporting.

In some examples of the method, apparatuses, and non-transitory computer-readable medium described herein, the reporting may be based on a first priority of a second message for which the first resource may be reserved by the second UE relative to a second priority of a portion of the message corresponding to a slot overlapping in time with the first resource.

In some examples of the method, apparatuses, and non-transitory computer-readable medium described herein, the reporting may be based on a first priority of a second message for which the first resource may be reserved by the second UE relative to a second priority of the message over the first group of consecutive resources.

In some examples of the method, apparatuses, and non-transitory computer-readable medium described herein, the reporting includes indicating preemption separately for each resource of a subset of the set of resources, the subset of the set of resources including the first resource and a second resource of the set of resources that overlaps with the first group of consecutive resources.

In some examples of the method, apparatuses, and non-transitory computer-readable medium described herein, the reporting includes indicating the first group of consecutive resources may have been preempted.

In some examples of the method, apparatuses, and non-transitory computer-readable medium described herein, the first group of consecutive resources overlaps with at least one resource of the set of resources available for preemption in time and frequency and the second group of consecutive resources may be non-overlapping in time and frequency with the first resource.

A method for wireless communication at a first UE is described. The method may include receiving, at a first layer of the first UE and from a second layer of the first UE, an indication of a set of resources available for preemption, selecting a first group of consecutive resources for transmitting a first message, where the first group of consecutive resources overlaps with a first resource of the set of resources available for preemption, determining that a second UE has reserved the first resource of the set of resources, reporting, from the first layer to the second layer, an indication that the first resource is being preempted based on determining that the second UE has reserved the first resource of the set of resources and a first priority of a second message for which the first resource is reserved by the second UE relative to a second priority of the first message over the first group of consecutive resources, and transmitting the first message over a second group of consecutive resources distinct from the first group of consecutive resources based on the reporting.

An apparatus for wireless communication at a first UE is described. The apparatus may include a processor, memory coupled with the processor, and instructions stored in the memory. The instructions may be executable by the processor to cause the apparatus to receive, at a first layer of the first UE and from a second layer of the first UE, an indication of a set of resources available for preemption, select a first group of consecutive resources for transmitting a first message, where the first group of consecutive resources overlaps with a first resource of the set of resources available for preemption, determine that a second UE has reserved the first resource of the set of resources, reporting, from the first layer to the second layer, an indication that the first resource be being preempted based on determining that the second UE has reserved the first resource of the set of resources and a first priority of a second message for which the first resource is reserved by the second UE relative to a second priority of the first message over the first group of consecutive resources, and transmit the first message over a second group of consecutive resources distinct from the first group of consecutive resources based on the reporting.

Another apparatus for wireless communication at a first UE is described. The apparatus may include means for receiving, at a first layer of the first UE and from a second layer of the first UE, an indication of a set of resources available for preemption, means for selecting a first group of consecutive resources for transmitting a first message, where the first group of consecutive resources overlaps with a first resource of the set of resources available for preemption, means for determining that a second UE has reserved the first resource of the set of resources, means for reporting, from the first layer to the second layer, an indication that the first resource is being preempted based on determining that the second UE has reserved the first resource of the set of resources and a first priority of a second message for which the first resource is reserved by the second UE relative to a second priority of the first message over the first group of consecutive resources, and means for transmitting the first message over a second group of consecutive resources distinct from the first group of consecutive resources based on the reporting.

A non-transitory computer-readable medium storing code for wireless communication at a first UE is described. The code may include instructions executable by a processor to receive, at a first layer of the first UE and from a second layer of the first UE, an indication of a set of resources available for preemption, select a first group of consecutive resources for transmitting a first message, where the first group of consecutive resources overlaps with a first resource of the set of resources available for preemption, determine that a second UE has reserved the first resource of the set of resources, reporting, from the first layer to the second layer, an indication that the first resource be being preempted based on determining that the second UE has reserved the first resource of the set of resources and a first priority of a second message for which the first resource is reserved by the second UE relative to a second priority of the first message over the first group of consecutive resources, and transmit the first message over a second group of consecutive resources distinct from the first group of consecutive resources based on the reporting.

In some examples of the method, apparatuses, and non-transitory computer-readable medium described herein, the reporting may be based on the second priority being higher than the first priority.

Some examples of the method, apparatuses, and non-transitory computer-readable medium described herein may further include operations, features, means, or instructions for determining that the first UE may have disabled preemption for the first group of consecutive resources and receiving, via radio resource control (RRC) signaling, an indication of a third priority, where the reporting may be based on the second priority being higher than the third priority and determining that the first UE may have disabled preemption for the first group of consecutive resources.

In some examples of the method, apparatuses, and non-transitory computer-readable medium described herein, the second priority being higher than the first priority includes the second priority being associated with a first channel access priority class that may have a lower value than a second channel access priority class associated with the second priority.

In some examples of the method, apparatuses, and non-transitory computer-readable medium described herein, the second priority includes a highest priority of a set of priorities for the message, each priority of the set of priorities corresponding to a respective resource of the first group of resources for the message.

In some examples of the method, apparatuses, and non-transitory computer-readable medium described herein, the first priority includes a highest priority of a set of priorities, each priority of the set of priorities corresponding to a respective resource of a subset of the set of resources available for preemption, the subset of the set of resources including resources reserved by the second UE and overlapping with the first group of consecutive resources.

In some examples of the method, apparatuses, and non-transitory computer-readable medium described herein, the second priority includes a highest priority of a set of priorities, each priority of the set of priorities corresponding to a respective resource of a subset of the first group of consecutive resources for the message, each resource of the subset of the first group of consecutive resources overlapping with a respective resource of the set of resources reserved by the second UE.

In some examples of the method, apparatuses, and non-transitory computer-readable medium described herein, the indication of the set of resources available for preemption includes an individual indication for each resource of the set of resources and each resource of the set of resources spans a slot.

In some examples of the method, apparatuses, and non-transitory computer-readable medium described herein, the indication of the set of resources includes an indication of one or more groups of consecutive resources.

In some examples of the method, apparatuses, and non-transitory computer-readable medium described herein, the reporting includes indicating preemption separately for each resource of a subset of the set of resources, the subset of the set of resources including the first resource and a second resource of the set of resources that overlaps with the first group of consecutive resources.

In some examples of the method, apparatuses, and non-transitory computer-readable medium described herein, the reporting includes indicating the first group of consecutive resources may have been preempted

### BRIEF DESCRIPTION OF THE DRAWINGS

FIG. 1 illustrates an example of a wireless communications system that supports enhanced pre-emption for multi-consecutive slot transmission in accordance with one or more aspects of the present disclosure.

FIG. 2 illustrates an example of a wireless communications system that supports enhanced pre-emption for multi-consecutive slot transmission in accordance with one or more aspects of the present disclosure.

FIGS. 3A and 3B illustrate examples of preemption resource indication schemes that support enhanced pre-emption for multi-consecutive slot transmission in accordance with one or more aspects of the present disclosure.

FIG. 4 illustrates an example of a resource selection scheme that supports enhanced pre-emption for multi-consecutive slot transmission in accordance with one or more aspects of the present disclosure.

FIG. 5 illustrates an example of a resource selection scheme that supports enhanced pre-emption for multi-consecutive slot transmission in accordance with one or more aspects of the present disclosure.

FIG. 6 illustrates an example of a process flow that supports enhanced pre-emption for multi-consecutive slot transmission in accordance with one or more aspects of the present disclosure.

FIGS. 7 and 8 illustrate block diagrams of devices that support enhanced pre-emption for multi-consecutive slot transmission in accordance with one or more aspects of the present disclosure.

FIG. 9 illustrates a block diagram of a communications manager that supports enhanced pre-emption for multi-consecutive slot transmission in accordance with one or more aspects of the present disclosure.

FIG. 10 illustrates a diagram of a system including a device that supports enhanced pre-emption for multi-consecutive slot transmission in accordance with one or more aspects of the present disclosure.

FIGS. 11 and 12 illustrate flowcharts showing methods that support enhanced pre-emption for multi-consecutive slot transmission in accordance with one or more aspects of the present disclosure.

### DETAILED DESCRIPTION

Some communications systems may support sidelink communications where user equipments (UEs) may transmit directly to each other. In some cases, UEs may select resources of a resource pool to use for sidelink transmissions to other UEs. For example, a first UE and a second UE may perform communications using resources of a resource pool. In some cases, the second UE may attempt to reserve a resource of the resource pool that has already been reserved by the first UE. If this reserved resource is available for preemption, the first UE may determine whether this resource may be pre-empted and, if so, may report the resource to be pre-empted to a higher layer (e.g., from a physical (PHY) layer of the first UE to a medium access control (MAC) layer of the first UE).

In some aspects, the first UE may reserve a group of consecutive resources of the resource pool for a multi-consecutive slot transmission (MCSt) (e.g., over resources consecutive in time). If the second UE reserves a resource of the resource pool already included in the reserved group of consecutive resources, the first UE may pre-empt the resource. However, if the pre-empted resource is not the last resource of the group of consecutive resources (e.g., is the first resource or one of the resources before the last resource), pre-empting the resource may result in the first UE losing channel occupancy during the time spanned by the pre-empted resource. As such, the first UE may fail to transmit over additional resources that follow the pre-empted resource. Additionally, the second UE may fail to contend for the channel for the pre-empted resource. In either or both of these scenarios, the efficiency of wireless communications may decrease.

The present disclosure describes techniques for performing pre-emption when the first UE or the second UE has reserved a group of consecutive resources for transmitting an MCSt. For instance, the first UE may receive, at a first layer of the first UE (e.g., a PHY layer) and from a second layer of the first UE (e.g., a higher layer, such as a MAC layer), an indication of a set of resources available for preemption. In some such examples, the indication of the set of resources may include an indication of one or more groups of consecutive resources (e.g., one indication for a group of consecutive resources as opposed to an individual indication for each resource of the group of consecutive resources). The first UE may select a first group of consecutive resources for transmitting a message, where the first group of consecutive resources overlaps with a first resource of the set of resources available for preemption. The first UE may determine that the second UE has reserved the first resource of the set of resources and may report, from the first layer to the second layer, an indication that the first resource is being preempted based on determining that the second UE has reserved the first resource of the set of resources. In some aspects, the reporting may be based on a first priority for a second message that the second UE is to transmit over the first resource relative to a second priority of the message for transmission by the first UE over the first group of consecutive resources. In some aspects, the first UE may report an indication of the first group of consecutive resources (e.g., one indication for the first group of consecutive resources as opposed to an individual indication for each resource of the first group of consecutive resources). After the reporting, the first UE may transmit the message over a second group of consecutive resources distinct from the first group of consecutive resources based on the reporting.

Aspects of the disclosure are initially described in the context of wireless communications systems. Additional aspects of disclosure are described in the context of preemption resource indication schemes, resource selection schemes, and a process flow. Aspects of the disclosure are further illustrated by and described with reference to apparatus diagrams, system diagrams, and flowcharts that relate to enhanced pre-emption for multi-consecutive slot transmission.

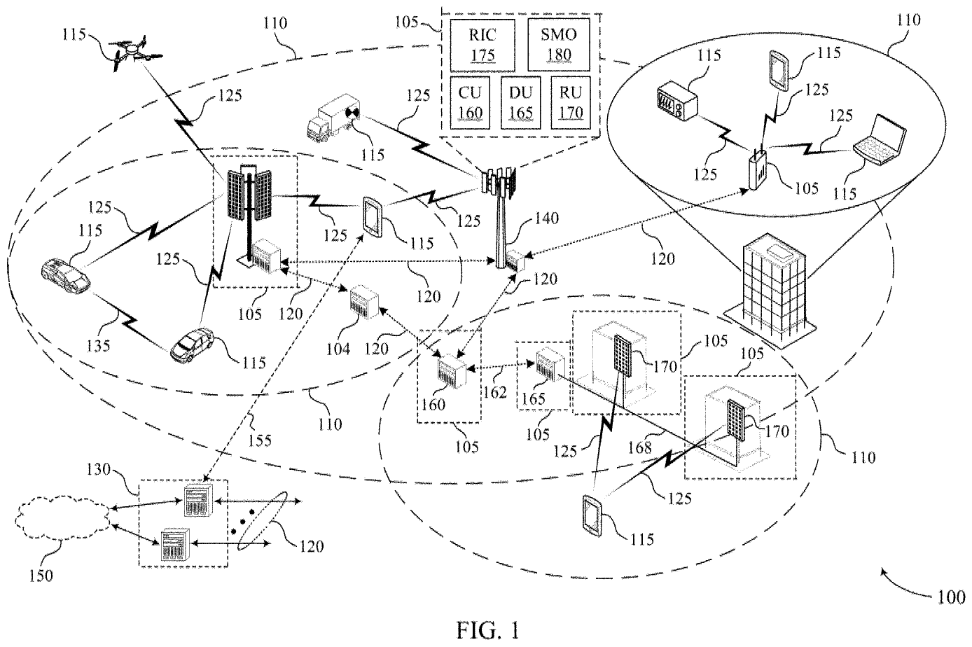

FIG. 1 illustrates an example of a wireless communications system 100 that supports enhanced pre-emption for multi-consecutive slot transmission in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) (e.g., RU 170), a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support enhanced pre-emption for multi-consecutive slot transmission as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some aspects, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some aspects, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some aspects, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some aspects, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some aspects, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some aspects, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some aspects, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some aspects, a UE 115 may perform resource selection (e.g., sidelink resource selection, resource selection in Mode 2). Performing the resource selection may include performing two steps. For instance, a first step may include the UE 115 identifying candidate resources by sensing and exclusion. A second step may include the UE 115 performing candidate resource selection from the identified resources. In some aspects, a higher layer of the UE 115 may perform the candidate resources selection.

In order to identify the candidate resources at the first step, the UE 115 may sense sidelink resources during a sensing window (e.g., when the UE 115 is not transmitting. The sensing window may be a time interval defined by a range of slots [n−T₀, N−T_{proc,0}), where n is the resource (re)selection trigger or slot at which new resources may be selected, T₀ is configured or preconfigured (e.g., 100 milliseconds (ms), 200 ms, 500 ms, 1000 ms, or 1100 ms), and T_{proc,0} may be a time involved in completing a sensing procedure. Additionally, the first step may include the UE 115 excluding candidate resources in a selection window (e.g., a selection window that occurs after the sensing window). The selection window may include each resource within a range of slots [n−T₁, n−T₂], where T₁ is a processing time involved in identifying candidate resources and selecting sidelink resources and where T₂ is in a range bounded by a minimum value (e.g., T_{2,min}) and a maximum value equal to a packet delay budget (PDB). In some aspects, the UE 115 may exclude any resources associated with resources in a slot of the sensing window in which the UE 115 transmitted as part of a half-duplex operation. Additionally, the UE 115 may exclude candidate resources based on reservations reserved from other UEs (e.g., in first-stage sidelink control information (SCI) detected during the sensing window). In some aspects, the first step may be performed in the PHY layer and after identifying the available candidate resources by sensing and exclusion, the PHY of the UE 115 may report the available candidate resources to the higher layer (e.g., MAC layer) of the UE.

In some aspects, the second step may include the higher layer randomly selecting the sidelink resources from the available candidate resources reported from the UE 115 PHY. To select N candidate resources from the available candidate resources, the UE 115 may first select randomly one of the N candidate resources (e.g., a candidate resource in slot m₁). Additionally, the UE 115 may select randomly a second candidate resource, with a constraint that a gap between the second candidate resource must be smaller than a window W of 32 slots. For instance, the second candidate resources may be located at slot m₂ within a range of slots [m₁−32, m₁+31]. If N is larger than 2, the UE 115 may select a third candidate resource with a constraint that it is located at slot m₃ within a range of slots [m₁−32, m₁+31] or [m₂−32, m₂+31]. The above procedure may be repeated until all the N candidate resources are selected.

If a higher layer of a UE 115 (e.g., the MAC layer) requests the UE 115 to determine a subset of resources from which the higher layer may select resources for a transmission (e.g., a physical sidelink shared channel (PSSCH) transmission or a physical sidelink control channel (PSCCH) transmission) as part of re-evaluation or a pre-emption procedure, the higher layer (e.g., UE MAC) may provide a set of resources (r₀, r₁, r₂, . . . ) which may be subject to re-evaluation and a set of resources

$$( {r}_{0}^{′} , {r}_{1}^{′} , {r}_{2}^{′} , … )$$

which may be subject to pre-emption.

In some aspects, reserved resources may be pre-empted by a higher priority reservation. If the resource meets one or more conditions the UE PHY may report pre-emption of the resource to the higher layer of the UE. For instance, if the resource is reserved by another UE 115 (e.g., with priority prio_{RX}), the UE 115 may report pre-emption of the resource. Additionally, if sl-PreemptionEnable is equal to (e.g., set to) ‘enabled’ and prio_{TX} (e.g., the priority of the transmission that the UE 115 has reserved the resource for) is greater than prio_{RX} or if sl-PreemptionEnable is not equal to (e.g., not set to) ‘enabled’ and prio_{TX} (e.g., the priority of the transmission that the UE 115 has reserved the resource for) is greater than prio_{RX} and prio_{RX}<prioₚᵣₑ, the UE 115 may report pre-emption of the resource. In some aspects, prioₚᵣₑ may be a priority level configured by sl-PreemptionEnable. In some aspects, for the priority values prio_{RX}, prio_{TX}, and prioₚᵣₑ a lower value may correspond to a higher priority. If a subset of reserved resources (e.g., M_{R} resources) are indicated for pre-emption by the UE PHY, the higher layer of the UE 115 may remove the M_{R} resources and may randomly select M_{R} new candidate resources from the available candidate resources within the new selection window.

In some examples, the resources which may be preempted may be defined as described herein. For instance, a UE 115 may report a set S_{A} (e.g., a set of resources) to higher layers. If a resource rᵢ from the set (r₀, r₁, r₂, . . . ) is not a member of S_{A} the UE 115 may report re-evaluation of the resource rᵢ to higher layers. If a resource

$${r}_{i}^{′}$$

from the set

$$( {r}_{0}^{′} , {r}_{1}^{′} , {r}_{2}^{′} , … )$$

meets one or more conditions, the UE 115 may report pre-emption of the resource

$${r}_{i}^{′}$$

to higher layers. For instance, if

$${r}_{i}^{′}$$

is not a member of S_{A}; if

$${r}_{i}^{′}$$

meets one or more conditions for exclusion according to a threshold (e.g., Th(prio_{RX}, prio_{TX})); and if prio_{TX}>prio_{RX} when sl-PreemptionEnable is equal to ‘enabled’ or prio_{TX}>prio_{RX} and prio_{RX}<prioₚᵣₑ when sl-PreemptionEnable is not equal to ‘enabled.’

In a shared spectrum (e.g., a sidelink unlicensed spectrum), UEs may transmit MCSts, which may increase an efficiency of channel utilization. As with a licensed band, a reserved resource for a UE may be pre-empted by another higher priority UE. The reserved resource pre-empted by another higher priority UE may be within an inner portion of the MCSt of the lower-priority UE (e.g., may include non-edge resources of the MCSt). In such examples, the lower-priority UE may lose a channel occupancy time (COT) and the higher-priority UE may fail to contend the channel. If the reserved resource of the lower-priority UE after the reserved resource which is pre-empted by the higher-priority UE has higher priority than the reserved resource of the higher-priority UE, the lower-priority UE may be incapable of transmitting higher priority traffic due to the loss of COT.

The techniques described herein provide enhancements for MCSt in a shared spectrum (e.g., sidelink unlicensed). For instance, the techniques described herein may include a higher layer indicating groups of consecutive resources available for preemption (e.g., as opposed to indicating only individual resources). Additionally or alternatively, the techniques described herein may include enhanced conditions for UE PHY reporting preemption of a resource to a higher layer of the UE 115 (e.g., using a priority of the MCSt for the conditions). Additionally or alternatively, the techniques described herein may include enhanced behavior of UE PHY for reporting preemption and/or the higher layer of the UE 115 after receiving the preemption indication (e.g., the UE PHY reporting MCSt resources as opposed to only reporting individual resources).

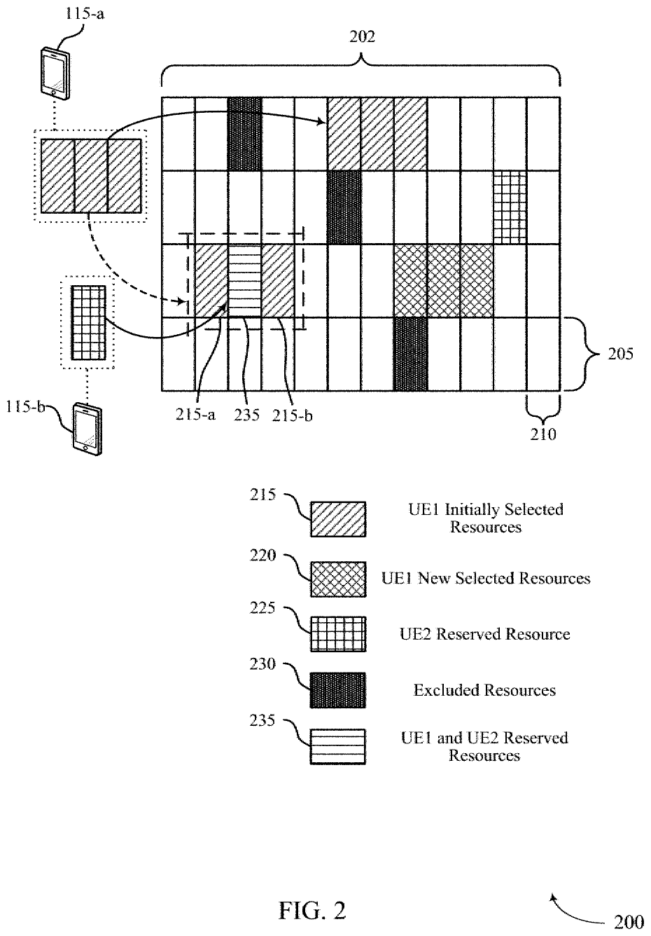

FIG. 2 illustrates an example of a wireless communications system 200 that supports enhanced pre-emption for multi-consecutive slot transmission in accordance with one or more aspects of the present disclosure. In some aspects, wireless communications system 200 may implement one or more aspects of wireless communications system 100. For instance, UES 115-a and 115-b may be examples of UEs 115 as described with reference to FIG. 1. In some aspects, UE 115-a may be referred to as UE1 and UE 115-b may be referred to as UE2.

UEs 115-a and 115-b may perform sidelink communications. In some aspects, UE 115-a may reserve resources 215 (e.g., including resources 215-a and 215-b) of selection window 202 and UE 115-b may reserve resources 225 of selection window 202. Additionally, selection window 202 may include excluded resources 230 that are unavailable for use by UE 115-a. In some aspects, UE 115-a may determine preemption for the reserved resources 215. For instance, UE 115-a may select a first group of consecutive resources (resources 215-a, 215-b, and 235) in a selection window 202 for transmitting a first message (e.g., an MCSt), where each resource of the selection window 202 may be defined according to one or more slots 210 and one or more sub-channels 205. However, UE 115-b may reserve a first resource for a second message that may overlap with the first group of consecutive resources (e.g., resource 235, which may be indicated in an SCI from UE 115-b).

In some aspects, UE 115-a may determine whether or not to report preemption for the first resource based on one or more conditions. In a first preemption condition scheme, if one or more single-slot resources in a multi-slot resource of an MCSt of UE 115-a are reserved by UE 115-b, UE 115-a may determine whether each resource of the one or more single-slot resources (e.g., resource 235) is to be preempted based on a priority of a transmission for UE 115-b on the each single-slot resource as compared to a priority of the MCSt on the single-slot resource. For instance, in the present example, a first priority of the first message on resource 235 may have the value prio_{TX} and a second priority of the second message on resource 235 may have the value prio_{RX}. If a preemption enable parameter (e.g., sl-PreemptionEnable) is equal to (e.g., set to) ‘enabled’ and prio_{TX} is greater than prio_{RX} or if the preemption enable parameter (e.g., sl-PreemptionEnable) is not equal to (e.g., not set to) ‘enabled’ and prio_{TX} is greater than prio_{RX} and prio_{RX}<prioₚᵣₑ, UE 115-a may report pre-emption of the resource. In some aspects, for the priority values prio_{RX}, prio_{TX}, and prioₚᵣₑ a lower value may correspond to a higher priority. For example, the priority values prio_{RX}, prio_{TX}, and prioₚᵣₑ may be channel access priority class (CAPC) values.

In a second preemption condition scheme, if one or more single-slot resources in a multi-slot resource of an MCSt of UE 115-a are reserved by UE 115-b, UE 115-a may determine whether all of the one or more single-slot resources in the multi-slot resource (e.g., resource 235) are to be preempted based on a priority of the MCSt relative to a priority associated with one or more transmissions of UE 115-b on the one or more single-slot resources. For instance, in the present example, a first priority of the MCSt for UE 115-a (e.g., prio_{TX,MCSt}) may be compared to a second priority for UE 115-b over the one or more single-slot resources (e.g., prio_{RX,MCSt}). In one aspect, UE 115-a may report preemption for the each of the one or more single-slot resources (e.g., for the entire multi-slot resource of the MCSt) based on if preemption for MCSt is equal to (e.g., set to) ‘enabled’ and if prio_{TX,MCSt} is greater than prio_{RX,MCSt} or if preemption for MCSt is not equal to (e.g., not set to) ‘enabled’ and if prio_{TX,MCSt} is greater than prio_{RX,MCSt} and if prio_{RX,MCSt}<prio_{pre,MCST}, where prio_{pre,MCST} may be a radio resource control (RRC)-configured priority level (e.g., CAPC value). In some aspects, UE 115-b may reserve the one or more single-slot resources for transmission of an MCSt for UE 115-b or may reserve the one or more single-slot resources for separate transmissions.

In some aspects, the first preemption condition scheme and the second preemption condition scheme for determining whether or not to report preemption may each determine whether a first preemption enable parameter (e.g., sl-PreemptionEnable) is equal to (e.g., set to) ‘enable’ (e.g., the first preemption condition scheme and second preemption condition scheme may share the same parameter). Alternatively, the first preemption condition scheme may use the first preemption enable parameter (e.g., sl-PreemptionEnable) and the second preemption condition scheme may determine whether or not to report preemption by determining whether a second preemption enable parameter (e.g., an MCSt preemption enable parameter) distinct from the first preemption enable parameter (e.g., sl-PreemptionEnable) is equal to (e.g., set to) ‘enable.’ In some aspects, prio_{pre,MCST} may equal prioₚᵣₑ. In such examples, prioₚᵣₑ may be configured and prio_{pre,MCST} may be determined from prioₚᵣₑ. In other examples, prioₚᵣₑ and prio_{pre,MCSt} may have different values. In such cases, prioₚᵣₑ and prio_{pre,MCSt} may be configured separately. In some examples, for prio_{TX,MCSt} and prio_{RX,MCSt} a lower value may be a higher priority. For example, prio_{TX,MCSt} and prio_{RX,MCSt} may be CAPC priority values.

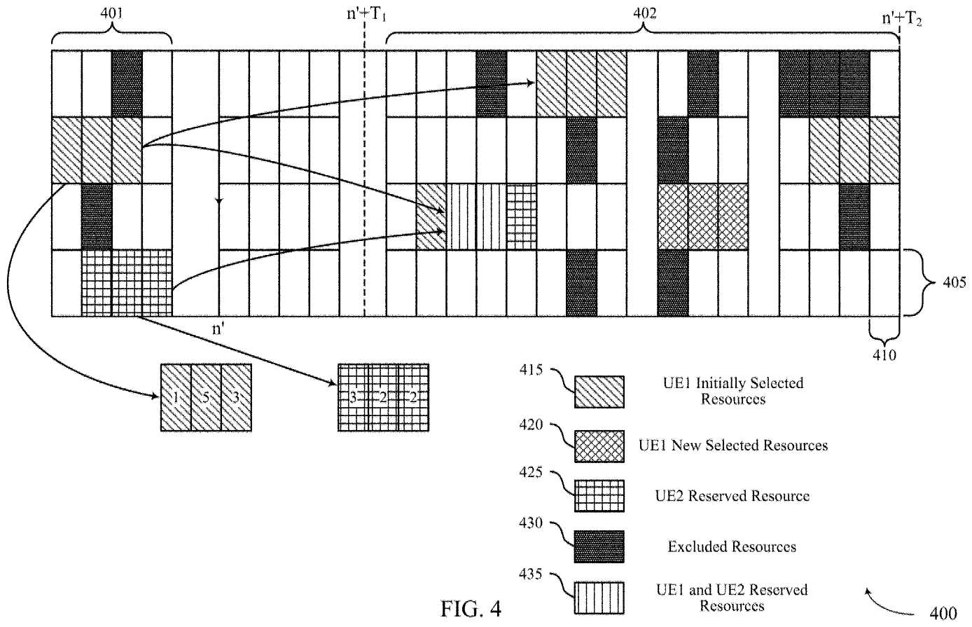

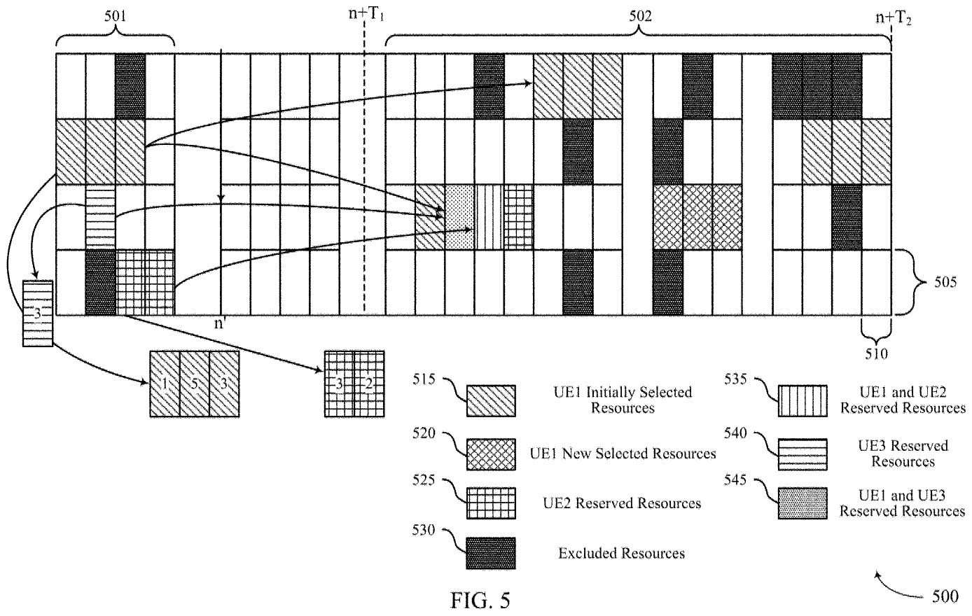

In some aspects, one or more slots in the multi-slot resource may be associated with a different priority (e.g., the MCSt over resource 215-a may be associated with a different priority than the MCSt over resource 235). In a first priority determination scheme, UE 115-a may select a highest priority among all of the single-slot resources of the MCSt (e.g., the highest priority among the priorities associated with each resource of the multi-slot resource, such as each of resources 215-a, 215-b, and 235). Alternatively, in a second priority determination scheme, UE 115-a may select a highest priority among all single-slot resources of the MCSt that overlap with a resource reserved by another UE (e.g., UE 115-b and any other UE that UE 115-a has detected as having overlapping resources). Alternatively, in a third priority determination scheme, UE 115-a may select a highest priority among all single-slot resources of the MCSt that overlap with a resource reserved by just UE 115-b (e.g., discounting resources from other UEs besides UE 115-b that overlap with the single-slot resources of the MCSt). Additional aspects concerning the priority determination schemes may be described herein, for instance, with reference to FIGS. 4 and 5.

After determining that the one or more single slot resources (e.g., the first resource, resource 235) are to be preempted, a PHY layer of UE 115-a may report the one or more single-slot resources to a higher layer (e.g., a MAC layer) of UE 115-a. In some aspects, the PHY of UE 115-a may report preemption for each single-slot resource (e.g., UE 115-a may provide an individual indication for each single-slot resource). In other examples, the PHY of UE 115-a may report preemption for an entire multi-slot resource of an MCSt (e.g., UE 115-a may provide a single indication for a multi-slot resource). In one aspect, one bit may be used to indicate one or more single-slot resources in a multi-slot resource of MCSt has been preempted. In another example, a bitmap may be used to indicate the exact preempted resource in a multi-slot resource of MCSt. In yet another example, UE 115-a may report a single preemption at the first preempted single-slot resource in a multi-slot resource of MCSt. After reporting the one or more single-slot resources to the higher layer, the higher layer may perform resource selection (e.g., the higher layer may select multi-slot resource 220 for transmitting the MCSt).

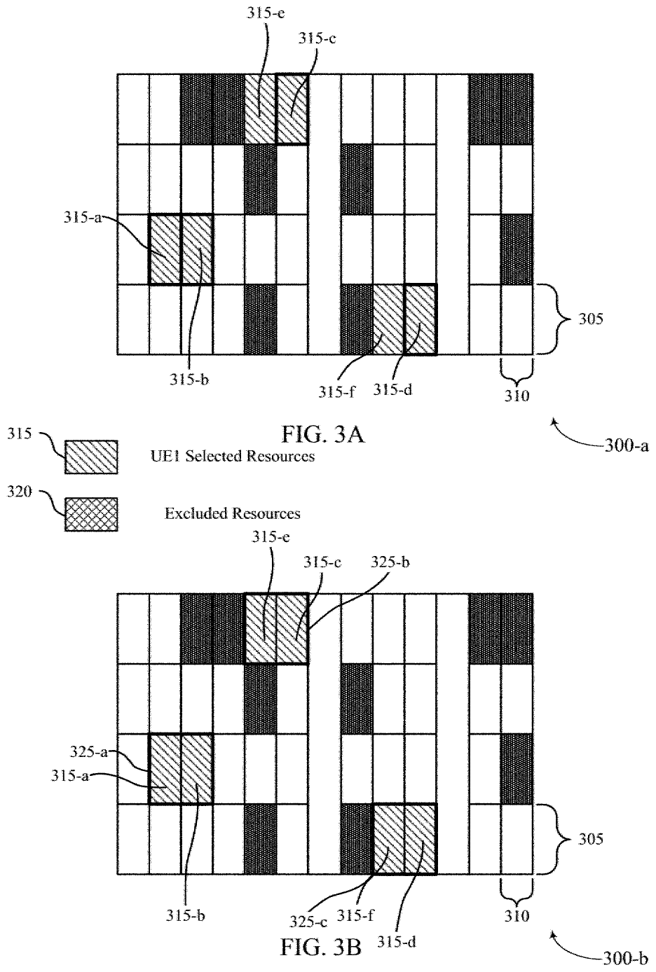

In some aspects, a higher layer (e.g., the MAC layer) may indicate a set of resources available for preemption (e.g., subject to preemption) prior to the UE determining whether or not to report preemption for a first resource overlapping the first group of consecutive resources. In some aspects, the higher layer may provide a set of single-slot resources subject to pre-emption. In other examples, the higher layer may provide a set of multi-slot resources which may be subject to pre-emption. Additional aspects concerning how the higher layer may indicate the set of resources may be described herein, for instance, with reference to FIGS. 3A and 3B.

In some aspects, the techniques described herein may be associated with one or more advantages. For instance, the higher layer indicating sets of multi-slot resources may be associated with reduced overhead (e.g., involve conveying less bits) as compared to indicating the individual resources in the multi-slot resource. Additionally, determining whether or not to preempt based on one priority of an MCSt as compared to different priorities of the MCSt may prevent UE 115-a from reporting preemption when one resource of the MCSt meets the conditions for preemption but another resource of the MCSt is associated with a priority that would cause the preemption conditions to fail. Thus, UE 115-a may retain COT during the one resource that meets the conditions for preemption.

FIGS. 3A and 3B illustrate examples of preemption resource indication schemes 300-a and 300-b that support enhanced pre-emption for multi-consecutive slot transmission in accordance with one or more aspects of the present disclosure. In some aspects, preemption resource indication schemes 300-a and 300-b may be implemented by and/or may implement one or more aspects of wireless communications systems 100 and/or 200. For instance, resource indication schemes 300-a and 300-b may depict a selection window 202 as described with reference to FIG. 2. Additionally or alternatively, each resource in resource indication schemes 300-a and 300-b may be defined by one or more slots 310 and one or more sub-channels 305, which may be examples of slots 210 and/or sub-channels 205 as described with reference to FIG. 2. In some aspects, the selected resources 315 may be examples of resources 215 as described with reference to FIG. 2 and excluded resources 320 may be an example of excluded resources 230 as described with reference to FIG. 2.

As depicted with reference to FIG. 3A, a higher layer of a UE (e.g., UE 115-a as described with reference to FIG. 2 or a UE 115 as described with reference to FIG. 1) may provide, to a PHY layer of the UE, a set of single-slot resources 315 subject to pre-emption. For instance, the higher layer of the UE may provide a set

$$( {r}_{0 , 1}^{′} , {r}_{1 , 1}^{′} , {r}_{2 , 1}^{′} , {r}_{3 , 1}^{′} , … ) , where {r}_{0 , 1}^{′}$$

may correspond to resource 315-a,

$${r}_{1 , 1}^{′}$$

may correspond to resource 315-b,

$${r}_{2 , 1}^{′}$$

may correspond to resource 315-c, and

$${r}_{3 , 1}^{′}$$

may correspond to resource 315-d. Accordingly, resources 315-a, 315-b, 315-c, and 315-d may be preempted as part of a resource selection procedure. In some aspects, resources 315-e and 315-f may not be indicated as subject to preemption. Accordingly, resources 315-e and 315-f may not be preempted as part of a resource selection procedure.

As depicted with reference to FIG. 3B, a higher layer of a UE may provide, to a PHY layer of the UE, a set of multi-slot resources 325 subject to pre-emption. For instance, the higher layer of the UE may provide a set

$$( {r}_{0 , 2}^{′} , {r}_{1 , 2}^{′} , {r}_{2 , 2}^{′} , … ) , where {r}_{0 , 2}^{′}$$

may correspond to multi-slot resource 325-a,

$${r}_{1 , 2}^{′}$$

may correspond to multi-slot resource 325-b, and

$${r}_{2 , 2}^{′}$$

may correspond to multi-slot resource 325-c. In some aspects, multi-slot resource 325-a may include resources 315-a and 315-b; multi-slot resource 325-b may include resources 315-c and 315-e, and multi-slot resource 325-c may include resources 315-d and 315-f. Accordingly, each of resources 315-a through 315-f may be subject to preemption.

FIG. 4 illustrates an example of a resource selection scheme 400 that supports enhanced pre-emption for multi-consecutive slot transmission in accordance with one or more aspects of the present disclosure. In some aspects, resource selection scheme 400 may be implemented by and/or may implement one or more aspects of wireless communications systems 100 and/or 200. For instance, resource selection scheme 400 may depict a selection window 402, which may be an example of a selection window 202 as described with reference to FIG. 2. Additionally or alternatively, each resource in resource selection scheme 400 may be defined by one or more slots 410 and one or more sub-channels 405, which may be examples of slots 210 and/or sub-channels 205 as described with reference to FIG. 2. In some aspects, selected resources 415 may be examples of resources 215 (e.g., selected resources of UE 115-a) as described with reference to FIG. 2; resources 425 may be an example of resources 225 (e.g., selected and/or reserved resources of UE 115-b) as described with reference to FIG. 2; resources 430 may be an example of excluded resources 230 as described with reference to FIG. 2; and resources 435 may be an example of resources 235 as described with reference to FIG. 2 (e.g., selected and/or reserved resources of UE 115-a and 115-b).

Resource selection scheme 400 may include a sensing window 401 and a selection window 402. Sensing window may start at a time n+T₁ and may end at a time n′. Selection window 402 may start at a time n′+T₁ and may end at a time n′+T₂. In some aspects, T₁ is a processing time involved in identifying candidate resources and selecting sidelink resources and, T₂ is in a range bounded by a minimum value (e.g., T_{2,min}) and a maximum value equal to a PDB. In some aspects, sensing window 401 may be used by a UE to sense candidate resources available for selection and selection window 402 may be used by a UE to schedule resources for transmitting messages.

In the present example, a first UE (e.g., UE 115-a as described with reference to FIG. 2) may select resources 415 for transmitting a first message (e.g., an MCSt). The resources may be part of a first multi-slot resource (e.g., an MCS resource). For instance, the resources may be consecutive with each other over time and there may be multiple of them. In the present example, a first resource 415 of the multi-slot resource for the first UE may be associated with a priority level of 1; a second resource 415 of the multi-slot resource for the first UE may be associated with a priority level of 5; and a third resource 415 of the multi-slot resource for the first UE may be associated with a priority level of 3, where lower priority values may indicate higher priority. Additionally, a second UE (e.g., UE 115-b as described with reference to FIG. 2) may select and/or reserve resources 425 for transmitting a second message (e.g., an MCSt). In some aspects, the resources may be part of a second multi-slot resource (e.g., an MCS resource). In the present example, a first resource 425 of the multi-slot resource for the second UE may be associated with a priority level of 3; a second resource 425 of the multi-slot resource for the second UE may be associated with a priority level of 2; and a third resource 425 of the multi-slot resource for the second UE may be associated with a priority level of 2.

In some aspects, resources for transmitting the first message may be mapped to the same resources for transmitting the second message in the selection window 402. For instance, in the present example, the first multi-slot resource and the second multi-slot resource may overlap to form resources 435. For instance, the second and third resources 415 of the first multi-slot resource may overlap with the first and second resources 425, respectively, of the second multi-slot resource UE to form first overlapping resource 435 and second overlapping resource 435, respectively. Additionally, the first resource 415 of the first multi-slot resource and the third resource 425 of the second multi-slot resource may not overlap with any resources of the second and first multi-slot resources, respectively.

In some aspects, the first UE may determine whether to perform preemption based on resources for transmitting the first message overlapping with resources for transmitting the second message. According to the first preemption condition scheme described herein (e.g., with regards to FIG. 2), the prio_{TX} for the second resource 415 of the first multi-slot resource may be 5 and prio_{RX} for the first resource 425 of the second multi-slot resource may be 3. Since prio_{TX}>prio_{RX} for the first overlapping resource 435 (e.g., and assuming that a preemption enable parameter is equal to ‘enabled’ or that the preemption enable parameter is equal to ‘disabled’ and that prio_{RX}<prioₚᵣₑ), the first UE may report preemption for the first overlapping resource 435. Additionally, according to the first preemption condition scheme described herein, the prio_{TX} for the third resource 415 of the first multi-slot resource may be 3 and prio_{RX} for the second resource 425 of the second multi-slot resource may be 2. Since prio_{TX}>prio_{RX} for the second overlapping resource 435 (e.g., and assuming that a preemption enable parameter is equal to ‘enabled’ or that the preemption enable parameter is equal to ‘disabled’ and that prio_{RX}<prioₚᵣₑ), the first UE may report preemption for the second overlapping resource 435.

In other examples, according to the first priority determination scheme for the second preemption condition scheme described herein (e.g., with regards to FIG. 2), the prio_{TX,MCSt} for the second resource 415 of the first multi-slot resource may be min{1,5,3}=1 and prio_{RX,MCSt} for the first resource 425 of the second multi-slot resource may be min{3,2,2}=2. Since prio_{TX,MCSt}<prio_{RX,MCSt} for the first overlapping resource 435, the first UE may not report preemption for the first overlapping resource 435. Additionally, according to the first priority determination scheme for the second preemption condition scheme described herein (e.g., with regards to FIG. 2), the prio_{TX,MCSt} for the third resource 415 of the first multi-slot resource may be min{1,5,3}=1 and prio_{RX,MCSt} for the second resource 425 of the second multi-slot resource may be min{3,2,2}=2. Since prio_{TX,MCSt}<prio_{RX,MCSt} for the second overlapping resource 435, the first UE may not report preemption for the second overlapping resource 435.

In other examples, according to the second priority determination scheme for the second preemption condition scheme described herein (e.g., with regards to FIG. 2), the prio_{TX,MCSt} for the second resource 415 of the first multi-slot resource may be min{5,3}=3 and prio_{RX,MCSt} for the first resource 425 of the second multi-slot resource may be min{3,2,2}=2. Since prio_{TX,MCSt}>prio_{RX,MCSt} for the first overlapping resource 435 (e.g., and assuming that a preemption enable parameter is equal to ‘enabled’ or that the preemption enable parameter is equal to ‘disabled’ and that prio_{RX,MCSt}<prio_{pre,MCSt}), the first UE may report preemption for the first overlapping resource 435. Additionally, according to the second priority determination scheme for the second preemption condition scheme described herein (e.g., with regards to FIG. 2), the prio_{TX,MCSt} for the third resource 415 of the first multi-slot resource may be min{5,3}=3 and prio_{RX,MCSt} for the second resource 425 of the second multi-slot resource may be min{3,2,2}=2. Since prio_{TX,MCSt}>prio_{RX,MCSt} for the second overlapping resource 435 (e.g., and assuming that a preemption enable parameter is equal to ‘enabled’ or that the preemption enable parameter is equal to ‘disabled’ and that prio_{RX,MCSt}<prio_{pre,MCSt}), the first UE may report preemption for the second overlapping resource 435.

In other examples, according to the third priority determination scheme for the second preemption condition scheme described herein (e.g., with regards to FIG. 2), the prio_{TX,MCSt} for the second resource 415 of the first multi-slot resource may be min{5,3}=3 and prio_{RX,MCSt} for the first resource 425 of the second multi-slot resource may be min{3,2}=2. Since prio_{TX,MCSt}>prio_{RX,MCSt} for the first overlapping resource 435 (e.g., and assuming that a preemption enable parameter is equal to ‘enabled’ or that the preemption enable parameter is equal to ‘disabled’ and that prio_{RX,MCSt}<prio_{pre,MCSt}), the first UE may report preemption for the first overlapping resource 435. Additionally, according to the third priority determination scheme for the second preemption condition scheme described herein (e.g., with regards to FIG. 2), the prio_{TX,MCSt} for the third resource 415 of the first multi-slot resource may be min{5,3}=3 and prio_{RX,MCSt} for the second resource 425 of the second multi-slot resource may be min{3,2}=2. Since prio_{TX,MCSt}>prio_{RX,MCSt} for the second overlapping resource 435 (e.g., and assuming that a preemption enable parameter is equal to ‘enabled’ or that the preemption enable parameter is equal to ‘disabled’ and that prio_{RX,MCSt}<prio_{pre,MCSt}), the first UE may report preemption for the second overlapping resource 435.

If the first UE reports preemption for the first overlapping resource 435 and/or the second overlapping resource 435 (e.g., if the preemption conditions are met), the first UE may select new resources 420 in the selection window 402 for transmitting the first message. If the first UE does not report preemption for the first overlapping resource 435 and the second overlapping resource 435, the first UE may transmit the first message over the initially selected resources (e.g., the first resource 415 of the first multi-slot resource and the first and second overlapping resources 435).

FIG. 5 illustrates an example of a resource selection scheme 500 that supports enhanced pre-emption for multi-consecutive slot transmission in accordance with one or more aspects of the present disclosure. In some aspects, resource selection scheme 500 may be implemented by and/or may implement one or more aspects of wireless communications systems 100 and/or 200. For instance, resource selection scheme 500 may depict a selection window 502, which may be an example of a selection window 202 as described with reference to FIG. 2. Additionally or alternatively, each resource in resource selection scheme 500 may be defined by one or more slots 510 and one or more sub-channels 505, which may be examples of slots 210 and/or sub-channels 205 as described with reference to FIG. 2. In some aspects, selected resources 515 may be examples of resources 515 (e.g., selected resources of UE 115-a) as described with reference to FIG. 2; resources 525 may be an example of resources 225 (e.g., selected and/or reserved resources of UE 115-b) as described with reference to FIG. 2; resources 530 may be an example of excluded resources 230 as described with reference to FIG. 2; and resources 535 may be an example of resources 235 as described with reference to FIG. 2 (e.g., selected and/or reserved resources of UE 115-a and 115-b).

Resource selection scheme 500 may include a sensing window 501 and a selection window 502. Sensing window may start at a time n+T₁ and may end at a time n′. Selection window 502 may start at a time n′+T₁ and may end at a time n′+T₂. In some aspects, T₁ is a processing time involved in identifying candidate resources and selecting sidelink resources and, T₂ is in a range bounded by a minimum value (e.g., T_{2,min}) and a maximum value equal to a PDB. In some aspects, sensing window 501 may be used by a UE to sense candidate resources available for selection and selection window 502 may be used by a UE to schedule resources for transmitting messages.

In the present example, a first UE (e.g., UE 115-a as described with reference to FIG. 2) may select resources 515 for transmitting a first message (e.g., an MCSt). The resources may be part of a first multi-slot resource (e.g., an MCS resource). For instance, the resources may be consecutive with each other over time and there may be multiple of them. In the present example, a first resource 515 of the multi-slot resource for the first UE may be associated with a priority level of 1; a second resource 515 of the multi-slot resource for the first UE may be associated with a priority level of 5; and a third resource 515 of the multi-slot resource for the first UE may be associated with a priority level of 3. Additionally, a second UE (e.g., UE 115-b as described with reference to FIG. 2) may select and/or reserve resources 525 for transmitting a second message (e.g., an MCSt). In some aspects, the resources may be part of a second multi-slot resource (e.g., an MCS resource). In the present example, a first resource 525 of the multi-slot resource for the second UE may be associated with a priority level of 3 and a second resource 525 of the multi-slot resource for the second UE may be associated with a priority level of 2. Additionally, a third UE (e.g., a UE 115 as described with reference to FIG. 1) may select and/or reserve a resource 540 for transmitting a third message. In some aspects, the resource 540 may be associated with a priority level of 3.

In some aspects, resources for transmitting the first message may be mapped to the same resources for transmitting the second message and/or the resource for transmitting the third message in the selection window 502. For instance, the first multi-slot resource and the resource 540 of the third UE may overlap to form a first overlapping resource 545. For instance, the second resource 515 of the first multi-slot resource may overlap with the resource 540 of the third UE to form a first overlapping resource 545. Additionally, the first multi-slot resource and the second multi-slot resource may overlap to form second overlapping resource 535. For instance, the third resource 515 of the first multi-slot resource may overlap with the first resource 525 of the second multi-slot resource UE to form second overlapping resource 535. Additionally, the first resource 515 of the first multi-slot resource and the second resource 525 of the second multi-slot resource may not overlap with any resources of the second multi-slot resource or the first multi-slot resource, respectively, or of the resource 540 of the third UE.

In some aspects, the first UE may determine whether to perform preemption based on resources for transmitting the first message overlapping with resources for transmitting the second message and/or for transmitting the third message. According to the first preemption condition scheme described herein (e.g., with regards to FIG. 2), the prio_{TX} for the second resource 515 of the first multi-slot resource may be 5 and prio_{RX} for the resource 540 of the third UE may be 3. Since prio_{TX}>prio_{RX} for the first overlapping resource 545 (e.g., and assuming that a preemption enable parameter is equal to ‘enabled’ or that the preemption enable parameter is equal to ‘disabled’ and that prio_{RX}<prioₚᵣₑ), the first UE may report preemption for the first overlapping resource 545. Additionally, according to the first preemption condition scheme described herein, the prio_{TX} for the third resource 515 of the first multi-slot resource may be 3 and prio_{RX} for the first resource 525 of the second multi-slot resource may be 3. Since prio_{TX} is not greater than prio_{RX} for the second overlapping resource 535, the first UE may not report preemption for the second overlapping resource 535.

In other examples, according to the first priority determination scheme for the second preemption condition scheme described herein (e.g., with regards to FIG. 2), the prio_{TX,MCSt} for the second resource 515 of the first multi-slot resource may be min{1,5,3}=1 and prio_{RX,MCSt} for the resource 540 of the third UE may be min{3}=3. Since prio_{TX,MCSt}<prio_{RX,MCSt} for the first overlapping resource 545, the first UE may not report preemption for the first overlapping resource 545. Additionally, according to the first priority determination scheme for the second preemption condition scheme described herein (e.g., with regards to FIG. 2), the prio_{TX,MCSt} for the third resource 515 of the first multi-slot resource may be min{1,5,3}=1 and prio_{RX,MCSt} for the first resource 525 of the second multi-slot resource may be min{3,2}=2. Since prio_{TX,MCSt}<prio_{RX,MCSt} for the second overlapping resource 535, the first UE may not report preemption for the second overlapping resource 535.

In other examples, according to the second priority determination scheme for the second preemption condition scheme described herein (e.g., with regards to FIG. 2), the prio_{TX,MCSt} for the second resource 515 of the first multi-slot resource may be min{5,3}=3 and prio_{RX,MCSt} for the resource 540 of the third UE may be min{3}=3. Since prio_{TX,MCSt} is not greater than prio_{RX,MCSt} for the first overlapping resource 545, the first UE may not report preemption for the first overlapping resource 545. Additionally, according to the second priority determination scheme for the second preemption condition scheme described herein (e.g., with regards to FIG. 2), the prio_{TX,MCSt} for the third resource 515 of the first multi-slot resource may be min{3}=3 and prio_{RX,MCSt} for the first resource 525 of the second multi-slot resource may be min{3,2}=2. Since prio_{TX,MCSt}>prio_{RX,MCSt} for the second overlapping resource 535 (e.g., and assuming that a preemption enable parameter is equal to ‘enabled’ or that the preemption enable parameter is equal to ‘disabled’ and that prio_{RX,MCSt}<prio_{pre,MCSt}), the first UE may report preemption for the second overlapping resource 535.

In other examples, according to the third priority determination scheme for the second preemption condition scheme described herein (e.g., with regards to FIG. 2), the prio_{TX,MCSt} for the second resource 515 of the first multi-slot resource may be min{5}=5 and prio_{RX,MCSt} for the resource 540 of the third UE may be min{3}=3. Since prio_{TX,MCSt}>prio_{RX,MCSt} for the first overlapping resource 545 (e.g., and assuming that a preemption enable parameter is equal to ‘enabled’ or that the preemption enable parameter is equal to ‘disabled’ and that prio_{RX,MCSt}<prio_{pre,MCSt}), the first UE may report preemption for the first overlapping resource 545. Additionally, according to the third priority determination scheme for the second preemption condition scheme described herein (e.g., with regards to FIG. 2), the prio_{TX,MCSt} for the third resource 515 of the first multi-slot resource may be min{3}=3 and prio_{RX,MCSt} for the first resource 525 of the second multi-slot resource may be min{3}=3. Since prio_{TX,MCSt} is not greater than prio_{RX,MCSt} for the second overlapping resource 535, the first UE may not report preemption for the second overlapping resource 535.

If the first UE reports preemption for the first overlapping resource 545 and/or the second overlapping resource 535 (e.g., if the preemption conditions are met), the first UE may select new resources 520 in the selection window 502 for transmitting the first message. If the first UE does not report preemption for the first overlapping resource 545 and the second overlapping resource 535, the first UE may transmit the first message over the initially selected resources (e.g., the first resource 415 of the first multi-slot resource, the first overlapping resource 545, and the second overlapping resource 535).

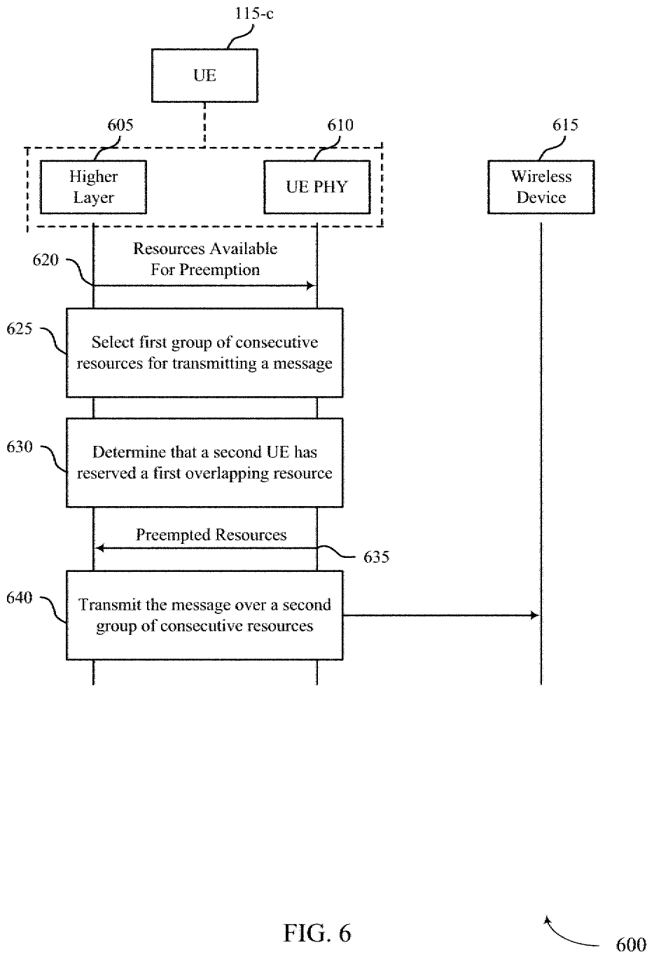

FIG. 6 illustrates an example of a process flow 600 that supports enhanced pre-emption for multi-consecutive slot transmission in accordance with one or more aspects of the present disclosure. In some aspects, process flow 600 may be implemented by one or more aspects of wireless communications systems 100 and/or 200. For instance, UE 115-c may be an example of a UE 115 as described with reference to FIG. 1 or a UE 115-a as described with reference to FIG. 2. Additionally, wireless device 615 may be an example of a UE 115 as described with reference to FIG. 1 or a network entity as described with reference to FIG. 1. In some aspects, Higher layer 605 may represent a higher layer of UE 115-c (e.g., a MAC layer) and UE PHY 610 may represent a PHY layer of UE 115-c.

At 620, higher layer 605 may provide, to UE PHY 610, an indication of a set of resources available for preemption. In some aspects, the indication of the set of resources includes an indication one or more groups of consecutive resources. In some aspects, the indication of the set of resources available for preemption includes an individual indication for each resource of the set of resources, where each resource of the set of resource spans a slot.

At 625, UE 115-c may select a first group of consecutive resources for transmitting a first message, where the first group of consecutive resources overlaps with a first resource of the set of resources available for preemption.

At 630, UE 115-c may determine that a second UE has reserved the first resource of the set of resources (e.g., UE 115-c may receive an SCI from the second UE scheduling the first resource).

At 635, UE PHY 610 may report, to higher layer 605, an indication that the first resource is being preempted based on receiving the indication that the second UE has reserved the first resource of the set of resources. In some aspects, the reporting may be based on a first priority of a second message for which the first resource is reserved by the second UE relative to a second priority of a portion of the message corresponding to a slot overlapping in time with the first resource. In some aspects, the reporting is based on the first priority of the second message for which the resource is reserved by the second UE relative to a priority of the message over the first group of consecutive resources. In some aspects, the reporting includes indicating preemption separately for each resource of a subset of the set of resources, the subset of the set of resources including the first resource and a second resource of the set of resources that overlaps with the first group of consecutive resources. In some aspects, the reporting includes indicating the first group of consecutive resources has been preempted. In some aspects, the reporting is based on the second priority being higher than the first priority. Alternatively, the reporting is based on the second priority being lower than the first priority. In some aspects, UE 115-c may determine that UE 115-c has disabled preemption for the first group of consecutive resources and may receive, via RRC signaling, an indication of a third priority, where the reporting is based on the second priority being higher than the third priority and determining that UE 115-a has disabled preemption for the first group of consecutive resources. In some aspects, the second priority includes a highest priority of a set of priorities for the message, each priority of the set of priorities corresponding to a respective resource of a subset of the set of resources available for preemption, the subset of the set of resources including resources reserved by the second UE and overlapping with the first group of consecutive resources. In some aspects, the second priority includes a highest priority of a set of priorities, where each priority of the set of priorities corresponds to a respective resource of a subset of the first group of consecutive resources for the first message, and where each resource of the subset of the first group of consecutive resources overlaps with respective resource of the set of resources reserved by the second UE.

At 640, UE 115-c may transmit the first message over a second group of consecutive resources distinct from the first group of consecutive resources based on the reporting. In some aspects, the first group of consecutive resources overlaps with at least one resource of the set of resources available for preemption in time and frequency, and the second group of consecutive resources is non-overlapping in time and frequency with the first resource. In some aspects, the first priority and the second priority may each be associated with a different channel access priority class (CAPC) (e.g., a lower CAPC value may correspond to a higher priority).

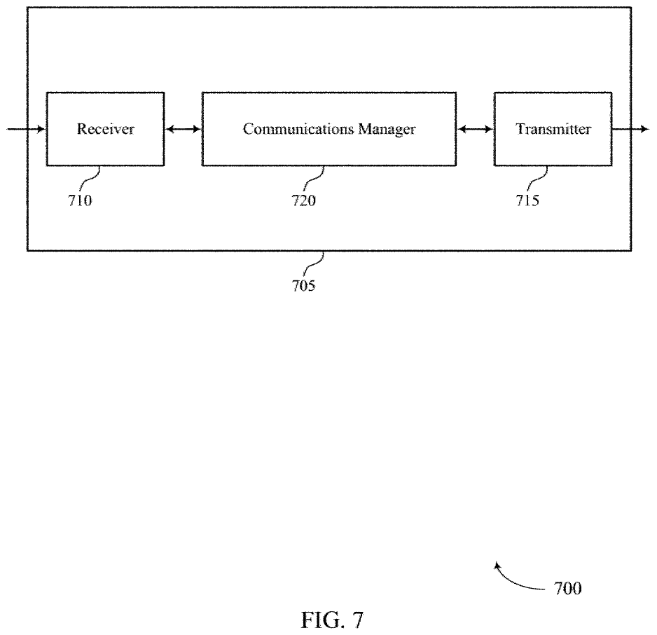

FIG. 7 illustrates a block diagram 700 of a device 705 that supports enhanced pre-emption for multi-consecutive slot transmission in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to enhanced pre-emption for multi-consecutive slot transmission). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to enhanced pre-emption for multi-consecutive slot transmission). In some aspects, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of enhanced pre-emption for multi-consecutive slot transmission as described herein. For example, the communications manager 720, the receiver 710, the transmitter 715, or various combinations or components thereof may support a method for performing one or more of the functions described herein.

In some aspects, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a first UE in accordance with examples as disclosed herein. For example, the communications manager 720 may be configured as or otherwise support a means for receiving, at a first layer of the first UE and from a second layer of the first UE, an indication of a set of resources available for preemption, where the indication of the set of resources includes an indication of one or more groups of consecutive resources. The communications manager 720 may be configured as or otherwise support a means for selecting a first group of consecutive resources for transmitting a message, where the first group of consecutive resources overlaps with a first resource of the set of resources available for preemption. The communications manager 720 may be configured as or otherwise support a means for receiving an indication that a second UE has reserved the first resource of the set of resources. The communications manager 720 may be configured as or otherwise support a means for reporting, from the first layer to the second layer, an indication that the first resource being preempted based on receiving the indication that the second UE has reserved the first resource of the set of resources. The communications manager 720 may be configured as or otherwise support a means for transmitting the message over a second group of consecutive resources distinct from the first group of consecutive resources based on the reporting.

Additionally, or alternatively, the communications manager 720 may support wireless communication at a first UE in accordance with examples as disclosed herein. For example, the communications manager 720 may be configured as or otherwise support a means for receiving, at a first layer of the first UE and from a second layer of the first UE, an indication of a set of resources available for preemption. The communications manager 720 may be configured as or otherwise support a means for selecting a first group of consecutive resources for transmitting a first message, where the first group of consecutive resources overlaps with a first resource of the set of resources available for preemption. The communications manager 720 may be configured as or otherwise support a means for receiving an indication that a second UE has reserved the first resource of the set of resources. The communications manager 720 may be configured as or otherwise support a means for reporting, from the first layer to the second layer, an indication that the first resource being preempted based on receiving the indication that the second UE has reserved the first resource of the set of resources and a first priority of a second message for which the first resource is reserved by the second UE relative to a second priority of the first message over the first group of consecutive resources. The communications manager 720 may be configured as or otherwise support a means for transmitting the first message over a second group of consecutive resources distinct from the first group of consecutive resources based on the reporting.

By including or configuring the communications manager 720 in accordance with examples as described herein, the device 705 (e.g., a processor controlling or otherwise coupled with the receiver 710, the transmitter 715, the communications manager 720, or a combination thereof) may support techniques for enabling a UE to avoid reporting preemption in scenarios in which a priority of a MCSt is lower in a slot overlapping with a transmission from another UE as compared to another slot of the MCSt, thus enabling the UE to retain COT.

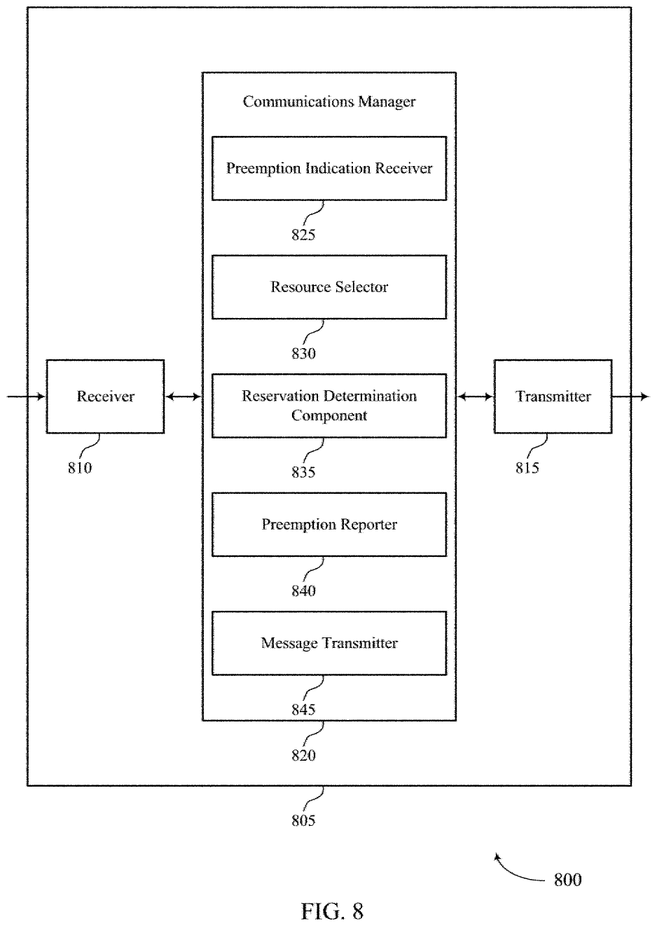

FIG. 8 illustrates a block diagram 800 of a device 805 that supports enhanced pre-emption for multi-consecutive slot transmission in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to enhanced pre-emption for multi-consecutive slot transmission). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to enhanced pre-emption for multi-consecutive slot transmission). In some aspects, the transmitter 815 may be co-located with a receiver 810 in a transceiver module. The transmitter 815 may utilize a single antenna or a set of multiple antennas.

The device 805, or various components thereof, may be an example of means for performing various aspects of enhanced pre-emption for multi-consecutive slot transmission as described herein. For example, the communications manager 820 may include a preemption indication receiver 825, a resource selector 830, a reservation determination component 835, a preemption reporter 840, a message transmitter 845, or any combination thereof. The communications manager 820 may be an example of aspects of a communications manager 720 as described herein. In some aspects, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication at a first UE in accordance with examples as disclosed herein. The preemption indication receiver 825 may be configured as or otherwise support a means for receiving, at a first layer of the first UE and from a second layer of the first UE, an indication of a set of resources available for preemption, where the indication of the set of resources includes an indication of one or more groups of consecutive resources. The resource selector 830 may be configured as or otherwise support a means for selecting a first group of consecutive resources for transmitting a message, where the first group of consecutive resources overlaps with a first resource of the set of resources available for preemption. The reservation determination component 835 may be configured as or otherwise support a means for receiving an indication that a second UE has reserved the first resource of the set of resources. The preemption reporter 840 may be configured as or otherwise support a means for reporting, from the first layer to the second layer, an indication that the first resource is being preempted based on receiving the indication that the second UE has reserved the first resource of the set of resources. The message transmitter 845 may be configured as or otherwise support a means for transmitting the message over a second group of consecutive resources distinct from the first group of consecutive resources based on the reporting.

Additionally, or alternatively, the communications manager 820 may support wireless communication at a first UE in accordance with examples as disclosed herein. The preemption indication receiver 825 may be configured as or otherwise support a means for receiving, at a first layer of the first UE and from a second layer of the first UE, an indication of a set of resources available for preemption. The resource selector 830 may be configured as or otherwise support a means for selecting a first group of consecutive resources for transmitting a first message, where the first group of consecutive resources overlaps with a first resource of the set of resources available for preemption. The reservation determination component 835 may be configured as or otherwise support a means for receiving an indication that a second UE has reserved the first resource of the set of resources. The preemption reporter 840 may be configured as or otherwise support a means for reporting, from the first layer to the second layer, an indication that the first resource is being preempted based on receiving the indication that the second UE has reserved the first resource of the set of resources and a first priority of a second message for which the first resource is reserved by the second UE relative to a second priority of the first message over the first group of consecutive resources. The message transmitter 845 may be configured as or otherwise support a means for transmitting the first message over a second group of consecutive resources distinct from the first group of consecutive resources based on the reporting.

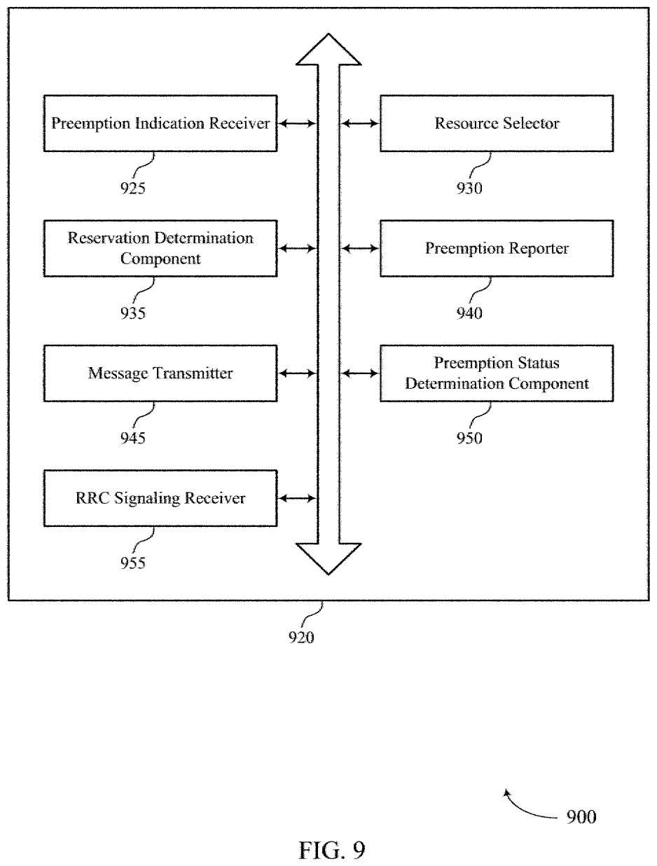

FIG. 9 illustrates a block diagram 900 of a communications manager 920 that supports enhanced pre-emption for multi-consecutive slot transmission in accordance with one or more aspects of the present disclosure. The communications manager 920 may be an example of aspects of a communications manager 720, a communications manager 820, or both, as described herein. The communications manager 920, or various components thereof, may be an example of means for performing various aspects of enhanced pre-emption for multi-consecutive slot transmission as described herein. For example, the communications manager 920 may include a preemption indication receiver 925, a resource selector 930, a reservation determination component 935, a preemption reporter 940, a message transmitter 945, a preemption status determination component 950, an RRC signaling receiver 955, or any combination thereof. Each of these components may communicate, directly or indirectly, with one another (e.g., via one or more buses).

The communications manager 920 may support wireless communication at a first UE in accordance with examples as disclosed herein. The preemption indication receiver 925 may be configured as or otherwise support a means for receiving, at a first layer of the first UE and from a second layer of the first UE, an indication of a set of resources available for preemption, where the indication of the set of resources includes an indication of one or more groups of consecutive resources. The resource selector 930 may be configured as or otherwise support a means for selecting a first group of consecutive resources for transmitting a message, where the first group of consecutive resources overlaps with a first resource of the set of resources available for preemption. The reservation determination component 935 may be configured as or otherwise support a means for receiving an indication that a second UE has reserved the first resource of the set of resources. The preemption reporter 940 may be configured as or otherwise support a means for reporting, from the first layer to the second layer, an indication that the first resource is being preempted based on receiving the indication that the second UE has reserved the first resource of the set of resources. The message transmitter 945 may be configured as or otherwise support a means for transmitting the message over a second group of consecutive resources distinct from the first group of consecutive resources based on the reporting.

In some aspects, the reporting is based on a first priority of a second message for which the first resource is reserved by the second UE relative to a second priority of a portion of the message corresponding to a slot overlapping in time with the first resource.

In some aspects, the reporting is based on a first priority of a second message for which the first resource is reserved by the second UE relative to a second priority of the message over the first group of consecutive resources.

In some aspects, the reporting includes indicating preemption separately for each resource of a subset of the set of resources, the subset of the set of resources including the first resource and a second resource of the set of resources that overlaps with the first group of consecutive resources.

In some aspects, the reporting includes indicating the first group of consecutive resources has been preempted.

In some aspects, the first group of consecutive resources overlaps with at least one resource of the set of resources available for preemption in time and frequency. In some aspects, the second group of consecutive resources is non-overlapping in time and frequency with the first resource.

Additionally, or alternatively, the communications manager 920 may support wireless communication at a first UE in accordance with examples as disclosed herein. In some aspects, the preemption indication receiver 925 may be configured as or otherwise support a means for receiving, at a first layer of the first UE and from a second layer of the first UE, an indication of a set of resources available for preemption. In some aspects, the resource selector 930 may be configured as or otherwise support a means for selecting a first group of consecutive resources for transmitting a first message, where the first group of consecutive resources overlaps with a first resource of the set of resources available for preemption. In some aspects, the reservation determination component 935 may be configured as or otherwise support a means for receiving an indication that a second UE has reserved the first resource of the set of resources. In some aspects, the preemption reporter 940 may be configured as or otherwise support a means for reporting, from the first layer to the second layer, an indication that the first resource is being preempted based on receiving the indication that the second UE has reserved the first resource of the set of resources and a first priority of a second message for which the first resource is reserved by the second UE relative to a second priority of the first message over the first group of consecutive resources. In some aspects, the message transmitter 945 may be configured as or otherwise support a means for transmitting the first message over a second group of consecutive resources distinct from the first group of consecutive resources based on the reporting.

In some aspects, the reporting is based on the second priority being higher than the first priority.

In some aspects, the preemption status determination component 950 may be configured as or otherwise support a means for determining that the first UE has disabled preemption for the first group of consecutive resources. In some aspects, the RRC signaling receiver 955 may be configured as or otherwise support a means for receiving, via RRC signaling, an indication of a third priority, where the reporting is based on the second priority being higher than the third priority and determining that the first UE has disabled preemption for the first group of consecutive resources.

In some aspects, the second priority being higher than the first priority includes the second priority being associated with a first channel access priority class that has a lower value than a second channel access priority class associated with the second priority.

In some aspects, the second priority includes a highest priority of a set of priorities for the message, each priority of the set of priorities corresponding to a respective resource of the first group of resources for the message.

In some aspects, the first priority includes a highest priority of a set of priorities, each priority of the set of priorities corresponding to a respective resource of a subset of the set of resources available for preemption, the subset of the set of resources including resources reserved by the second UE and overlapping with the first group of consecutive resources.

In some aspects, the second priority includes a highest priority of a set of priorities, each priority of the set of priorities corresponding to a respective resource of a subset of the first group of consecutive resources for the message, each resource of the subset of the first group of consecutive resources overlapping with a respective resource of the set of resources reserved by the second UE.

In some aspects, the indication of the set of resources available for preemption includes an individual indication for each resource of the set of resources. In some aspects, each resource of the set of resources spans a slot.

In some aspects, the indication of the set of resources includes an indication of one or more groups of consecutive resources.

In some aspects, the reporting includes indicating preemption separately for each resource of a subset of the set of resources, the subset of the set of resources including the first resource and a second resource of the set of resources that overlaps with the first group of consecutive resources.

In some aspects, the reporting includes indicating the first group of consecutive resources has been preempted.

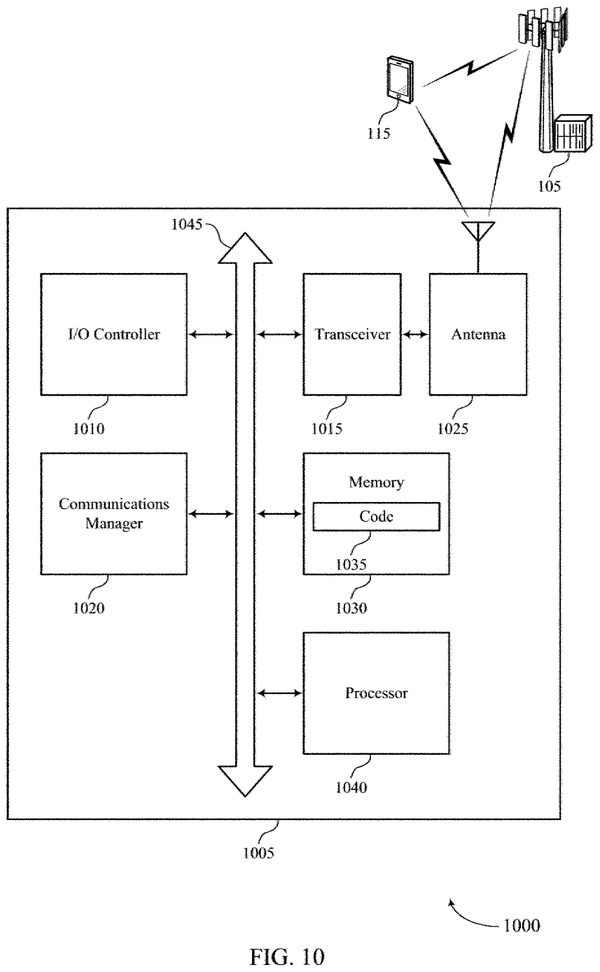

FIG. 10 illustrates a diagram of a system 1000 including a device 1005 that supports enhanced pre-emption for multi-consecutive slot transmission in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting enhanced pre-emption for multi-consecutive slot transmission). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communication at a first UE in accordance with examples as disclosed herein. For example, the communications manager 1020 may be configured as or otherwise support a means for receiving, at a first layer of the first UE and from a second layer of the first UE, an indication of a set of resources available for preemption, where the indication of the set of resources includes an indication of one or more groups of consecutive resources. The communications manager 1020 may be configured as or otherwise support a means for selecting a first group of consecutive resources for transmitting a message, where the first group of consecutive resources overlaps with a first resource of the set of resources available for preemption. The communications manager 1020 may be configured as or otherwise support a means for receiving an indication that a second UE has reserved the first resource of the set of resources. The communications manager 1020 may be configured as or otherwise support a means for reporting, from the first layer to the second layer, an indication that the first resource being preempted based on receiving the indication that the second UE has reserved the first resource of the set of resources. The communications manager 1020 may be configured as or otherwise support a means for transmitting the message over a second group of consecutive resources distinct from the first group of consecutive resources based on the reporting.

Additionally, or alternatively, the communications manager 1020 may support wireless communication at a first UE in accordance with examples as disclosed herein. For example, the communications manager 1020 may be configured as or otherwise support a means for receiving, at a first layer of the first UE and from a second layer of the first UE, an indication of a set of resources available for preemption. The communications manager 1020 may be configured as or otherwise support a means for selecting a first group of consecutive resources for transmitting a first message, where the first group of consecutive resources overlaps with a first resource of the set of resources available for preemption. The communications manager 1020 may be configured as or otherwise support a means for receiving an indication that a second UE has reserved the first resource of the set of resources. The communications manager 1020 may be configured as or otherwise support a means for reporting, from the first layer to the second layer, an indication that the first resource being preempted based on receiving the indication that the second UE has reserved the first resource of the set of resources and a first priority of a second message for which the first resource is reserved by the second UE relative to a second priority of the first message over the first group of consecutive resources. The communications manager 1020 may be configured as or otherwise support a means for transmitting the first message over a second group of consecutive resources distinct from the first group of consecutive resources based on the reporting.

By including or configuring the communications manager 1020 in accordance with examples as described herein, the device 1005 may support techniques for enabling a UE to avoid reporting preemption in scenarios in which a priority of a MCSt is lower in a slot overlapping with a transmission from another UE as compared to another slot of the MCSt, thus enabling the UE to retain COT.

In some aspects, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some aspects, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of enhanced pre-emption for multi-consecutive slot transmission as described herein, or the processor 1040 and the memory 1030 may be otherwise configured to perform or support such operations.

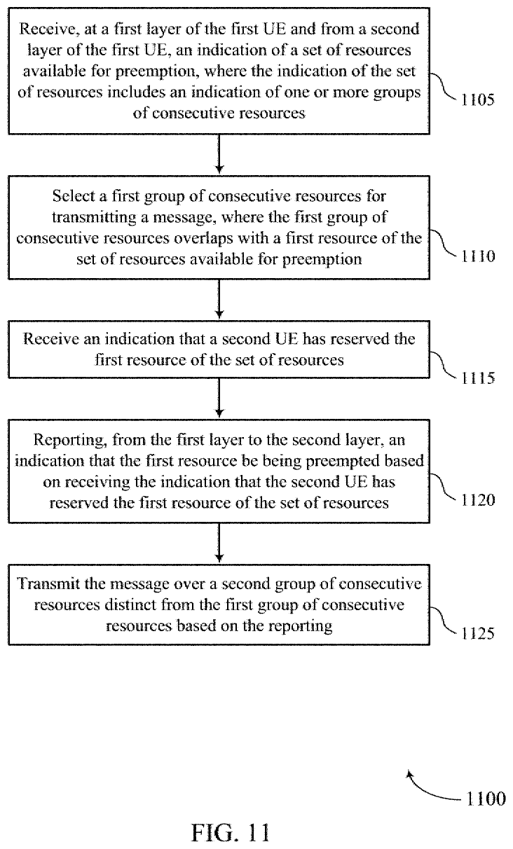

FIG. 11 illustrates a flowchart showing a method 1100 that supports enhanced pre-emption for multi-consecutive slot transmission in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some aspects, a UE may execute a set of instructions to control the functional elements of the UE to perform the described functions. Additionally, or alternatively, the UE may perform aspects of the described functions using special-purpose hardware.

At 1105, the method may include receiving, at a first layer of the first UE and from a second layer of the first UE, an indication of a set of resources available for preemption, where the indication of the set of resources includes an indication of one or more groups of consecutive resources. The operations of 1105 may be performed in accordance with examples as disclosed herein. In some aspects, aspects of the operations of 1105 may be performed by a preemption indication receiver 925 as described with reference to FIG. 9.

At 1110, the method may include selecting a first group of consecutive resources for transmitting a message, where the first group of consecutive resources overlaps with a first resource of the set of resources available for preemption. The operations of 1110 may be performed in accordance with examples as disclosed herein. In some aspects, aspects of the operations of 1110 may be performed by a resource selector 930 as described with reference to FIG. 9.

At 1115, the method may include receiving an indication that a second UE has reserved the first resource of the set of resources. The operations of 1115 may be performed in accordance with examples as disclosed herein. In some aspects, aspects of the operations of 1115 may be performed by a reservation determination component 935 as described with reference to FIG. 9.

At 1120, the method may include reporting, from the first layer to the second layer, an indication that the first resource is being preempted based on receiving the indication that the second UE has reserved the first resource of the set of resources. The operations of 1120 may be performed in accordance with examples as disclosed herein. In some aspects, aspects of the operations of 1120 may be performed by a preemption reporter 940 as described with reference to FIG. 9.

At 1125, the method may include transmitting the message over a second group of consecutive resources distinct from the first group of consecutive resources based on the reporting. The operations of 1125 may be performed in accordance with examples as disclosed herein. In some aspects, aspects of the operations of 1125 may be performed by a message transmitter 945 as described with reference to FIG. 9.

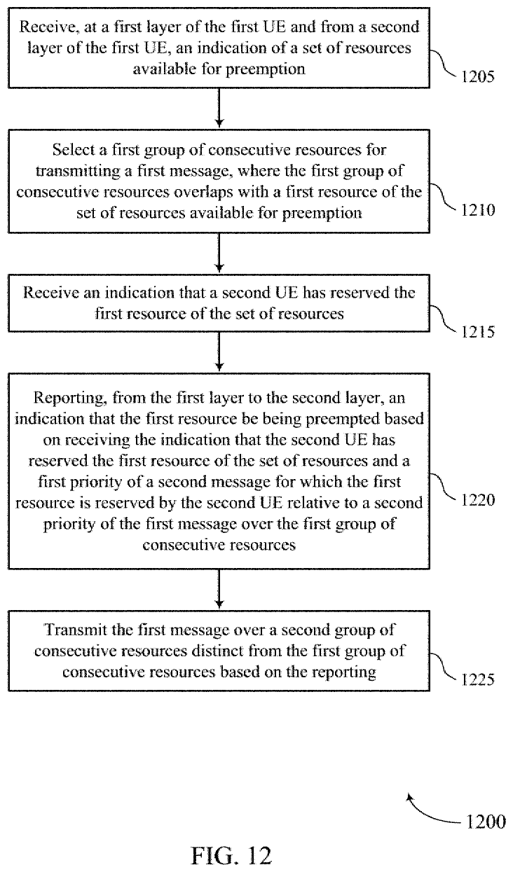

FIG. 12 illustrates a flowchart showing a method 1200 that supports enhanced pre-emption for multi-consecutive slot transmission in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some aspects, a UE may execute a set of instructions to control the functional elements of the UE to perform the described functions. Additionally, or alternatively, the UE may perform aspects of the described functions using special-purpose hardware.

At 1205, the method may include receiving, at a first layer of the first UE and from a second layer of the first UE, an indication of a set of resources available for preemption. The operations of 1205 may be performed in accordance with examples as disclosed herein. In some aspects, aspects of the operations of 1205 may be performed by a preemption indication receiver 925 as described with reference to FIG. 9.

At 1210, the method may include selecting a first group of consecutive resources for transmitting a first message, where the first group of consecutive resources overlaps with a first resource of the set of resources available for preemption. The operations of 1210 may be performed in accordance with examples as disclosed herein. In some aspects, aspects of the operations of 1210 may be performed by a resource selector 930 as described with reference to FIG. 9.

At 1215, the method may include receiving an indication that a second UE has reserved the first resource of the set of resources. The operations of 1215 may be performed in accordance with examples as disclosed herein. In some aspects, aspects of the operations of 1215 may be performed by a reservation determination component 935 as described with reference to FIG. 9.

At 1220, the method may include reporting, from the first layer to the second layer, an indication that the first resource is being preempted based on receiving the indication that the second UE has reserved the first resource of the set of resources and a first priority of a second message for which the first resource is reserved by the second UE relative to a second priority of the first message over the first group of consecutive resources. The operations of 1220 may be performed in accordance with examples as disclosed herein. In some aspects, aspects of the operations of 1220 may be performed by a preemption reporter 940 as described with reference to FIG. 9.

At 1225, the method may include transmitting the first message over a second group of consecutive resources distinct from the first group of consecutive resources based on the reporting. The operations of 1225 may be performed in accordance with examples as disclosed herein. In some aspects, aspects of the operations of 1225 may be performed by a message transmitter 945 as described with reference to FIG. 9.

The following provides an overview of aspects of the present disclosure:

Aspect 1: A method for wireless communication at a first UE, comprising: receiving, at a first layer of the first UE and from a second layer of the first UE, an indication of a set of resources available for preemption, wherein the indication of the set of resources comprises an indication of one or more groups of consecutive resources; selecting a first group of consecutive resources for transmitting a message, wherein the first group of consecutive resources overlaps with a first resource of the set of resources available for preemption; determining that a second UE has reserved the first resource of the set of resources; reporting, from the first layer to the second layer, an indication that the first resource is being preempted based at least in part on determining that the second UE has reserved the first resource of the set of resources; and transmitting the message over a second group of consecutive resources distinct from the first group of consecutive resources based at least in part on the reporting.

Aspect 2: The method of aspect 1, wherein the reporting is based at least in part on a first priority of a second message for which the first resource is reserved by the second UE relative to a second priority of a portion of the message corresponding to a slot overlapping in time with the first resource.

Aspect 3: The method of any of aspects 1 through 2, wherein the reporting is based at least in part on a first priority of a second message for which the first resource is reserved by the second UE relative to a second priority of the message over the first group of consecutive resources.

Aspect 4: The method of any of aspects 1 through 3, wherein the reporting comprises indicating preemption separately for each resource of a subset of the set of resources, the subset of the set of resources comprising the first resource and a second resource of the set of resources that overlaps with the first group of consecutive resources.

Aspect 5: The method of any of aspects 1 through 4, wherein the reporting comprises indicating the first group of consecutive resources has been preempted.

Aspect 6: The method of any of aspects 1 through 5, wherein the first group of consecutive resources overlaps with at least one resource of the set of resources available for preemption in time and frequency, and the second group of consecutive resources is non-overlapping in time and frequency with the first resource.

Aspect 7: A method for wireless communication at a first UE, comprising: receiving, at a first layer of the first UE and from a second layer of the first UE, an indication of a set of resources available for preemption; selecting a first group of consecutive resources for transmitting a first message, wherein the first group of consecutive resources overlaps with a first resource of the set of resources available for preemption; determining that a second UE has reserved the first resource of the set of resources; reporting, from the first layer to the second layer, an indication that the first resource is being preempted based at least in part on determining that the second UE has reserved the first resource of the set of resources and a first priority of a second message for which the first resource is reserved by the second UE relative to a second priority of the first message over the first group of consecutive resources; and transmitting the first message over a second group of consecutive resources distinct from the first group of consecutive resources based at least in part on the reporting.

Aspect 8: The method of aspect 7, wherein the reporting is based at least in part on the second priority being higher than the first priority.

Aspect 9: The method of aspect 8, further comprising: determining that the first UE has disabled preemption for the first group of consecutive resources; and receiving, via RRC signaling, an indication of a third priority, wherein the reporting is based at least in part on the second priority being higher than the third priority and determining that the first UE has disabled preemption for the first group of consecutive resources.

Aspect 10: The method of any of aspects 8 through 9, wherein the second priority being higher than the first priority comprises the second priority being associated with a first channel access priority class that has a lower value than a second channel access priority class associated with the second priority

Aspect 11: The method of any of aspects 7 through 10, wherein the second priority comprises a highest priority of a set of priorities for the message, each priority of the set of priorities corresponding to a respective resource of the first group of resources for the message.

Aspect 12: The method of any of aspects 7 through 11, wherein the first priority comprises a highest priority of a set of priorities, each priority of the set of priorities corresponding to a respective resource of a subset of the set of resources available for preemption, the subset of the set of resources comprising resources reserved by the second UE and overlapping with the first group of consecutive resources.

Aspect 13: The method of any of aspects 7 through 12, wherein the second priority comprises a highest priority of a set of priorities, each priority of the set of priorities corresponding to a respective resource of a subset of the first group of consecutive resources for the message, each resource of the subset of the first group of consecutive resources overlapping with a respective resource of the set of resources reserved by the second UE.

Aspect 14: The method of any of aspects 7 through 13, wherein the indication of the set of resources available for preemption comprises an individual indication for each resource of the set of resources, and each resource of the set of resources spans a slot.

Aspect 15: The method of any of aspects 7 through 14, wherein the indication of the set of resources comprises an indication of one or more groups of consecutive resources.

Aspect 16: The method of any of aspects 7 through 15, wherein the reporting comprises indicating preemption separately for each resource of a subset of the set of resources, the subset of the set of resources comprising the first resource and a second resource of the set of resources that overlaps with the first group of consecutive resources.

Aspect 17: The method of any of aspects 7 through 16, wherein the reporting comprises indicating the first group of consecutive resources has been preempted.

Aspect 18: An apparatus for wireless communication at a first UE, comprising a processor; memory coupled with the processor; and instructions stored in the memory and executable by the processor to cause the apparatus to perform a method of any of aspects 1 through 6.

Aspect 19: An apparatus for wireless communication at a first UE, comprising at least one means for performing a method of any of aspects 1 through 6.

Aspect 20: A non-transitory computer-readable medium storing code for wireless communication at a first UE, the code comprising instructions executable by a processor to perform a method of any of aspects 1 through 6.

Aspect 21: An apparatus for wireless communication at a first UE, comprising a processor; memory coupled with the processor; and instructions stored in the memory and executable by the processor to cause the apparatus to perform a method of any of aspects 7 through 17.

Aspect 22: An apparatus for wireless communication at a first UE, comprising at least one means for performing a method of any of aspects 7 through 17.

Aspect 23: A non-transitory computer-readable medium storing code for wireless communication at a first UE, the code comprising instructions executable by a processor to perform a method of any of aspects 7 through 17.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communication at a first user equipment (UE), comprising:
a processor; and
memory coupled with the processor, wherein the memory comprises instructions executable by the processor to cause the apparatus to:
receive, at a first layer of the first UE and from a second layer of the first UE, an indication of a set of resources available for preemption, wherein the indication of the set of resources comprises an indication of one or more groups of consecutive resources;
select a first group of consecutive resources for transmitting a message, wherein the first group of consecutive resources overlaps with a first resource of the set of resources available for preemption;
receive an indication that a second UE has reserved the first resource of the set of resources;
reporting, from the first layer to the second layer, an indication that the first resource be being preempted based at least in part on receiving the indication that the second UE has reserved the first resource of the set of resources; and
transmit the message over a second group of consecutive resources distinct from the first group of consecutive resources based at least in part on the reporting.

2. The apparatus of claim 1, wherein the reporting is based at least in part on a first priority of a second message for which the first resource is reserved by the second UE relative to a second priority of a portion of the message corresponding to a slot overlapping in time with the first resource.

3. The apparatus of claim 1, wherein the reporting is based at least in part on a first priority of a second message for which the first resource is reserved by the second UE relative to a second priority of the message over the first group of consecutive resources.

4. The apparatus of claim 1, wherein the reporting comprises indicating preemption separately for each resource of a subset of the set of resources, the subset of the set of resources comprising the first resource and a second resource of the set of resources that overlaps with the first group of consecutive resources.

5. The apparatus of claim 1, wherein the reporting comprises indicating the first group of consecutive resources has been preempted.

6. The apparatus of claim 1, wherein:
the first group of consecutive resources overlaps with at least one resource of the set of resources available for preemption in time and frequency, and
the second group of consecutive resources is non-overlapping in time and frequency with the first resource.

7. An apparatus for wireless communication at a first user equipment (UE), comprising:
a processor; and
memory coupled with the processor, wherein the memory comprises instructions executable by the processor to cause the apparatus to:
receive, at a first layer of the first UE and from a second layer of the first UE, an indication of a set of resources available for preemption;
select a first group of consecutive resources for transmitting a first message, wherein the first group of consecutive resources overlaps with a first resource of the set of resources available for preemption;
receive an indication that a second UE has reserved the first resource of the set of resources;
reporting, from the first layer to the second layer, an indication that the first resource be being preempted based at least in part on receiving the indication that the second UE has reserved the first resource of the set of resources and a first priority of a second message for which the first resource is reserved by the second UE relative to a second priority of the first message over the first group of consecutive resources; and
transmit the first message over a second group of consecutive resources distinct from the first group of consecutive resources based at least in part on the reporting.

8. The apparatus of claim 7, wherein the reporting is based at least in part on the second priority being higher than the first priority.

9. The apparatus of claim 8, wherein the instructions are further executable by the processor to cause the apparatus to:
determine that the first UE has disabled preemption for the first group of consecutive resources; and
receive, via radio resource control (RRC) signaling, an indication of a third priority, wherein the reporting is based at least in part on the second priority being higher than the third priority and determining that the first UE has disabled preemption for the first group of consecutive resources.

10. The apparatus of claim 8, wherein the second priority being higher than the first priority comprises the second priority being associated with a first channel access priority class that has a lower value than a second channel access priority class associated with the second priority.

11. The apparatus of claim 7, wherein the second priority comprises a highest priority of a set of priorities for the first message, each priority of the set of priorities corresponding to a respective resource of the first group of consecutive resources for the first message.

12. The apparatus of claim 7, wherein the first priority comprises a highest priority of a set of priorities, each priority of the set of priorities corresponding to a respective resource of a subset of the set of resources available for preemption, the subset of the set of resources comprising resources reserved by the second UE and overlapping with the first group of consecutive resources.

13. The apparatus of claim 7, wherein the second priority comprises a highest priority of a set of priorities, each priority of the set of priorities corresponding to a respective resource of a subset of the first group of consecutive resources for the first message, each resource of the subset of the first group of consecutive resources overlapping with a respective resource of the set of resources reserved by the second UE.

14. The apparatus of claim 7, wherein:
the indication of the set of resources available for preemption comprises an individual indication for each resource of the set of resources, and
each resource of the set of resources spans a slot.

15. The apparatus of claim 7, wherein the indication of the set of resources comprises an indication of one or more groups of consecutive resources.

16. The apparatus of claim 7, wherein the reporting comprises indicating preemption separately for each resource of a subset of the set of resources, the subset of the set of resources comprising the first resource and a second resource of the set of resources that overlaps with the first group of consecutive resources.

17. The apparatus of claim 7, wherein the reporting comprises indicating the first group of consecutive resources has been preempted.

18. A method for wireless communication implemented by a first user equipment (UE), comprising:
receiving, at a first layer of the first UE and from a second layer of the first UE, an indication of a set of resources available for preemption, wherein the indication of the set of resources comprises an indication of one or more groups of consecutive resources;
selecting a first group of consecutive resources for transmitting a message, wherein the first group of consecutive resources overlaps with a first resource of the set of resources available for preemption;
receiving an indication that a second UE has reserved the first resource of the set of resources;
reporting, from the first layer to the second layer, an indication that the first resource is being preempted based at least in part on receiving the indication that the second UE has reserved the first resource of the set of resources; and
transmitting the message over a second group of consecutive resources distinct from the first group of consecutive resources based at least in part on the reporting.

19. The method of claim 18, wherein the reporting is based at least in part on a first priority of a second message for which the first resource is reserved by the second UE relative to a second priority of a portion of the message corresponding to a slot overlapping in time with the first resource.

20. The method of claim 18, wherein the reporting is based at least in part on a first priority of a second message for which the first resource is reserved by the second UE relative to a second priority of the message over the first group of consecutive resources.
